(19) United States
(12) Patent Application Publication
(10) Pub. No.: US 2025/0139697 A1
(43) Pub. Date: May 1, 2025

(54) SYSTEMS AND METHODS FOR MODELING ACTIVITIES AND PERFORMANCE USERS

(71) Applicant: Wells Fargo Bank, N.A., San Francisco, CA (US)

(72) Inventors: Jim Carlough, San Francisco, CA (US); Chris A. Feathers, San Francisco, CA (US); Debashis Ghosh, Charlotte, NC (US); Rukiya Kelly, San Francisco, CA (US); Justin Morris Krieger, San Francisco, CA (US); Michael Restrepo, San Francisco, CA (US); Jane Turpin, San Francisco, CA (US); Matt Shuck, San Francisco, CA (US)

(73) Assignee: Wells Fargo Bank, N.A., San Francisco, CA (US)

(21) Appl. No.: 18/384,733

(22) Filed: Oct. 27, 2023

(51) Int. Cl. G06Q 40/03

(52) U.S. Cl. CPC G06Q 40/03

(57) ABSTRACT

Systems, methods, and computer-readable storage media for performance indicator operations are disclosed. One method includes identifying user activity data and one or more performance indicators of a user, and modeling the user activity data to generate one or more performance products including a plurality of performance parameters corresponding to a future performance indicator of the user. The method further includes generating and presenting a graphical user interface (GUI) including one or more actionable events associated with the plurality of performance parameters, and monitoring the user activity data and the one or more performance indicators of the user based on receiving new activity data corresponding to the future performance indicator from a user data source. The method further includes presenting one or more content items on the GUI including an indication of whether the user satisfies the plurality of performance parameters of the one or more performance products.

### TECHNICAL FIELD

The present disclosure relates generally to the field of performance analysis and content customization and presentation, including monitoring activities and performance of users.

### BACKGROUND

In a computer networked environment such as the internet, entities such as people or companies provide content for display associated with a performance with the entity. Entities that provide the content may desire to provide customized content associated with the customer's future performance and activities.

### SUMMARY

Some arrangements relate to a system. The system includes a processing circuit comprising memory and one or more processors, the processing circuit configured to identify user activity data and one or more performance indicators of a user. In some arrangements, the processing circuit is also configured to model the user activity data to generate one or more performance products comprising a plurality of performance parameters corresponding to a future performance indicator of the user. In some arrangements, the processing circuit is also configured to generate and present a graphical user interface (GUI) comprising one or more actionable events associated with the plurality of performance parameters. In some arrangements, the processing circuit is also configured to monitor the user activity data and the one or more performance indicators of the user based on receiving new activity data corresponding to the future performance indicator from a user data source. In some arrangements, the processing circuit is also configured to determine whether the new activity data satisfies the plurality of performance parameters of the one or more performance products. In some arrangements, the processing circuit is also configured to present one or more content items on the GUI comprising an indication of whether the user satisfies the plurality of performance parameters of the one or more performance products.

Some arrangements relate to a method. In some arrangements, the method includes identifying, by one or more processing circuits, user activity data and one or more performance indicators of a user. In some arrangements, the method also includes modeling, by the one or more processing circuits, the user activity data to generate one or more performance products comprising a plurality of performance parameters corresponding to a future performance indicator of the user. In some arrangements, the method also includes generating and presenting, by the one or more processing circuits, a graphical user interface (GUI) comprising one or more actionable events associated with the plurality of performance parameters. In some arrangements, the method also includes monitoring, by the one or more processing circuits, the user activity data and the one or more performance indicators of the user based on receiving new activity data corresponding to the future performance indicator from a user data source. In some arrangements, the method also includes determining, by the one or more processing circuits, whether the new activity data satisfies the plurality of performance parameters of the one or more performance products. In some arrangements, the method also includes presenting, by the one or more processing circuits, one or more content items on the GUI comprising an indication of whether the user satisfies the plurality of performance parameters of the one or more performance products.

Some arrangements relate to a computer-readable storage medium (CRM) having instructions stored thereon that, when executed by at least one processing circuit, cause the at least one processing circuit to perform operations. The operations include identifying user activity data and one or more performance indicators of a user. In some arrangements, the operations also include modeling the user activity data to generate one or more performance products comprising a plurality of performance parameters corresponding to a future performance indicator of the user. In some arrangements, the operations also include generating and presenting a graphical user interface (GUI) comprising one or more actionable events associated with the plurality of performance parameters. In some arrangements, the operations also include monitoring the user activity data and the one or more performance indicators of the user based on receiving new activity data corresponding to the future performance indicator from a user data source. In some arrangements, the operations also include determining whether the new activity data satisfies the plurality of performance parameters of the one or more performance products. In some arrangements, the operations also include presenting one or more content items on the GUI comprising an indication of whether the user satisfies the plurality of performance parameters of the one or more performance products.

### BRIEF DESCRIPTION OF THE DRAWINGS

FIG. 1 is a block diagram of an activity modeler architecture including an analysis system, according to example embodiments.

FIG. 2 is a block diagram illustrating an example computing system suitable for use in the example embodiments described herein.

FIG. 3 is a flow diagram of a method for modeling activities and performance of a user to generate performance products, according to example embodiments.

FIG. 4A is an illustration of a configuration of a user interface generated by the analysis system of FIG. 1, according to example embodiments.

FIG. 4B is an illustration of an additional configuration of a user interface generated by the analysis system of FIG. 1, according to example embodiments.

FIG. 4C is an illustration of an additional configuration of a user interface generated by the analysis system of FIG. 1, according to example embodiments.

FIG. 4D is an illustration of an additional configuration of a user interface generated by the analysis system of FIG. 1, according to example embodiments.

FIG. 4E is an illustration of an additional configuration of a user interface generated by the analysis system of FIG. 1, according to example embodiments.

FIG. 4F is an illustration of an additional configuration of a user interface generated by the analysis system of FIG. 1, according to example embodiments.

### DETAILED DESCRIPTION

Referring generally to the Figures, the systems and methods described herein relate to modeling activities and performance of a user to generate performance products. The systems and methods described herein generally relate to processing and predicting performance trajectories using activity data and current performance indicators. In typical systems, a computing device can present a variety of content (e.g., within the viewpoint of the computing device) relating to compartmentalized and often stale performance of the user. The systems and methods described herein generally relate to modeling current and previous activity and performance of the user to generate performance products achievable within a time frame after one or more performance indicators are updated over the time frame. Oftentimes, users may not qualify for one or more performance products at a specific point in time. In many systems, they cannot predict if the user may qualify for the performance product at a future point in time if the users performs one or more actionable activities or events. Thus, the present disclosure relates to accurately modeling current and past activity and performance of the user to generate customized performance products the users could qualify for at a future point in time.

Additionally, in some systems regarding performance, the entity can be presented with a performance indicator that is days, weeks, months, or years old. Having a performance indicator that is not based on current interaction data can lead to an entity's reliance on a non-current performance indicator, leading to a decision or lack of decision-making that can affect a future performance, adversely affecting an entity's profile and their knowledge thereof. Accordingly, the present disclosure is directed to systems and methods for generating, providing, and presenting a real-time (or near real-time), holistic view of a user's performance (e.g., current economic credit position, account status, etc.). The user's performance can then be used to generate performance products and predict future performance indicators. The present disclosure is aimed at improving both usability and data security, ensuring customer protected data (e.g., transaction data, financial data, account data) stays within the purview of operating providers (e.g., credit reporting agencies) while still providing insights to the entity. That is, the systems and methods mitigate the need to share this sensitive data across providers, thereby further enhancing data security.

Moreover, the present disclosure is directed towards improvements in existing forecasting architectures. The present disclosure enhances the precision of data analysis by using a predictive model to generate performance products and projected future performance indicators of users. The predictive model of the present disclosure improves existing systems by accurately anticipating future activities and potential events to achieve one or more performance products associated with performance parameters based on a predictive model that adapts to each customer's activity and habits. The present disclosure is directed towards capabilities that go beyond providing a performance product at the present time through a predictive model capable of dynamically generating and monitoring performance product progress over time and across providers.

Furthermore, the systems and methods of the present disclosure are directed towards improvements to economic tools that are generally passive. The present disclosure provides for active systems capable of generating actionable events and monitoring potential un-advantageous situations to provide an active personalized tool to reduce potential negative events associated with a customer or provider institutions and improve product utilization of a provider. The customized system of the present disclosure is individualist and provides improvements to data validation and extraction processes. Additionally, the user specific graphical user interfaces provide the end user with control over how the content is executed, providing an improved user interface. Therefore, aspects of the present disclosure also address problems in content presentation by providing improved presentation technology for the presentation of content on computer devices. In particular, the present disclosure addresses the technical challenges in interfacing by presenting personalized content. In one example, one or more processing circuits of the electronic devices can determine the amount of use of each task and indicators over a period of time and determine how much memory has been allocated to various tasks and indicators over a period of time (e.g., analysis system tracking memory usage for incoming activity data and the effects on performance indicators or future performance indicators over a period of a time) such that adjustments to the user interface can be done in real-time (e.g., end high memory usage processes, allocate more memory usage to certain processes, enable more memory for usage, and so on).

An additional technical improvement described herein encompasses the system's capability to conduct deep semantic analysis on user activity data. This allows the system to not just rely on quantitative data but also to extract qualitative insights from user interactions. By understanding the context and nuances of user activity, the systems and methods disclosed herein can model performance indicators with a heightened level of precision and accuracy. Furthermore, the improved GUI has been designed to incorporate real-time data visualization techniques. As the system continuously monitors and receives new activity data, the GUI dynamically updates visual representations, offering users an intuitive understanding of their progress towards meeting the performance parameters. These technical refinements provide users with a richer, more insightful interaction experience while ensuring that the generated performance products are tailored to individual user trajectories.

Another technical improvement pertains to the system's predictive analytics in relation to memory management when dealing with a customer's performance indicator goals and the related timeframe. Leveraging algorithms, the system efficiently allocates memory resources based on the complexity and volume of data needed to assess the achievability of a performance indicator goal. The system dynamically adjusts memory distribution depending on the intricacy of reward structures and associated products. For example, if a user's objective of improving their credit score is linked to acquiring a mortgage, the memory allocated would be substantial, given the multidimensional data points evaluated. This provides improved performance while providing real-time feedback on the feasibility of the credit score goal and potential rewards, leading to optimal user experience and timely decision-making. In some embodiments, the system incorporates an advanced memory allocation algorithm specifically optimized for handling vast multidimensional datasets pertaining to performance indicator modeling and related reward mechanisms. Utilizing a combination of temporal locality (predicting the data access patterns based on recent accesses) and spatial locality (leveraging data that are adjacent to recently accessed data), the system prefetches relevant datasets into the cache memory, anticipating future operations. For example, when analyzing a user's trajectory towards a credit score improvement in relation to a mortgage product, the system dynamically fetches, into the high-speed cache, data subsets like historical credit transactions, loan histories, and related financial behaviors. This approach not only speeds up the decision-making process but also ensures efficient memory usage.

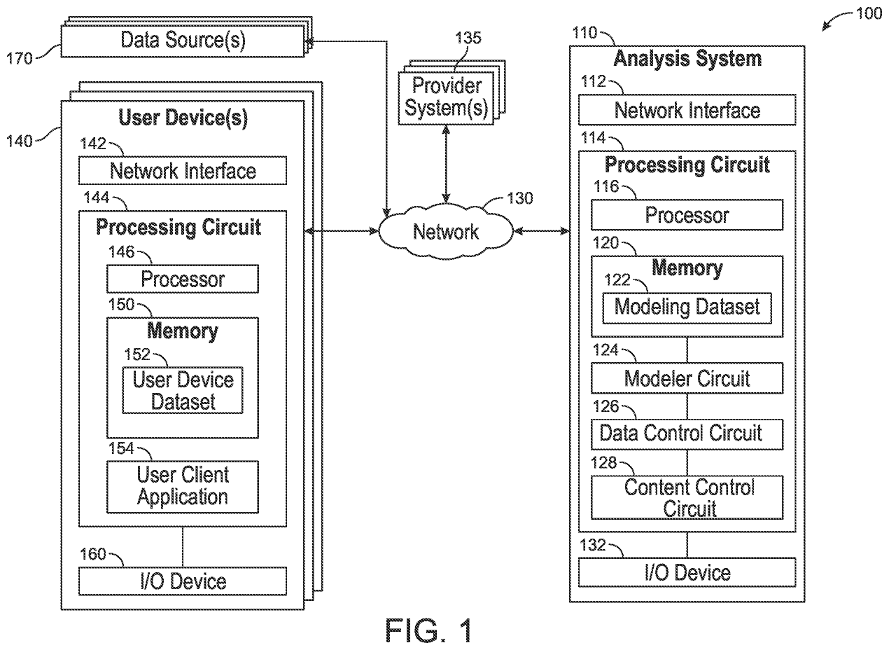

Referring to FIG. 1, a block diagram of an activity modeler architecture 100 including an analysis system 110 is shown, according to potential embodiments. The analysis system 110 can be associated with a provider, such as a service provider, bank, or financial institution (FI). The activity modeler architecture 100 further includes one or more user devices (e.g., user device 140), one or more data sources (e.g., data source 170), and an analysis system 110 (e.g., a computing system of a location of the FI). In some embodiments, the analysis system 110, user device 140 (as well as any additional user devices), and data source 170 are communicatively coupled. In some embodiments, the components of the activity modeler architecture 100 may be communicably and operatively coupled to each other over a network, such as network 130, that permits the direct or indirect exchange of data, values, instructions, messages, and the like (represented by the double-headed arrows in FIG. 1). The network 130 may include one or more of a cellular network, the Internet, Wi-Fi, Wi-Max, a proprietary provider network, a proprietary retail or service provider network, and/or any other kind of wireless or wired network.

Each system or device in activity modeler architecture 100 may include one or more processors, memories, and network interfaces (sometimes referred to herein as a “network circuit”). The memory may store programming logic that, when executed by the processor, controls the operation of the corresponding computing system or device. The memory may also store data in databases. For example, memory 120 may store programming logic that when executed by processor 116 within processing circuit 114, causes an update in the modeling dataset 122 from a user's account with information received from a user device 140 and/or data sources 170. The various components of devices in activity modeler architecture 100 may be implemented via hardware (e.g., circuitry), software (e.g., executable code), or any combination thereof. Devices and components in FIG. 1 can be added, deleted, integrated, separated, and/or rearranged in various embodiments of the disclosure.

The analysis system 110 may be operated by a provider. The analysis system 110 includes a network interface 112 and can be structured and used to establish connections with other computing systems and devices (e.g., the user devices 140, the data source 170, etc.) via the network 130. The network interface 112 includes program logic that facilitates connection of the analysis system 110 to the network 130. For example, the network interface 112 may include any combination of a wireless network transceiver (e.g., a cellular modem, a Bluetooth, transceiver, a WiFi, transceiver, etc.) and/or a wired network transceiver (e.g., an Ethernet transceiver). In some arrangements, the network interface 112 includes the hardware (e.g., processor, memory, and so on) and machine-readable media sufficient to support communication over multiple channels of data communication. Further, in some arrangements, the network interface 112 includes cryptography capabilities to establish a secure or relatively secure communication session in which data communicated over the session is encrypted. In various embodiments, the activity modeler architecture 100 can adapt to network traffic needs by compressing content, by any computing device described herein, and sending it (e.g., via network 130) to various other computing devices, by adjusting security filters to remove junk traffic off network 130 (e.g., by monitoring packets), and so on. While described with regards to a provider, the analysis system 110 may be used in other scenarios. For example, the analysis system 110 may be used at a car dealership or car rental company, a hotel, a booking agent, and/or a medical office.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The components of FIG. 1 are meant for illustrative purposes only and should not be regarded as limiting in any manner. The memory 120 may be one or more devices (e.g., RAM, ROM, Flash memory, hard disk storage) for storing data and/or computer code for completing and/or facilitating the various processes described herein. The memory 120 may be or include non-transient volatile memory, non-volatile memory, and non-transitory computer storage media. Memory 120 may include database components, object code components, script components, or any other type of information structure for supporting the various activities and information structures described herein. Memory 120 may be communicably coupled to the processor 116 and include computer code or instructions for executing one or more processes described herein. The processor 116 may be implemented as one or more application specific integrated circuits (ASICs), field programmable gate arrays (FPGAs), a group of processing components, or other suitable electronic processing components. As such, the analysis system 110 is configured to run a variety of application programs and store associated data in a database of the memory 120 (e.g., modeling dataset 122). One such application may be to provide data to the modeler circuit 124, data control circuit 126, and content control circuit 128.

Spatial and temporal locality principles provide the optimization of the processing circuit 114, particularly when it comes to efficient memory access. That is, spatial locality implies that the use of a specific memory location often correlates with the use of nearby memory locations. This is invaluable in the context of user data, where adjacent data points, such as consecutive credit transactions, are frequently accessed together. By efficiently grouping and prefetching this related data, the system enhances retrieval times and minimizes lag, ensuring real-time responses for user requests. Temporal locality, on the other hand, is predicated on the notion that previously accessed data is likely to be accessed again in the near future. By caching such frequently accessed data, the memory 120 can provide quicker access times for repetitive tasks, enhancing overall system efficiency. Leveraging both these concepts, the processing circuit 114 optimally manages its memory allocation, ensuring that relevant data, whether it's based on spatial proximity or recent access patterns, is promptly available for the processor 116 and other associated circuits.

As used herein, “activity data” refers to data of an account and/or identifier that is associated with economic or financial positions of the user. That is, activity data may create inferences about a person's borrowing practices. In some embodiments, activity data may involve qualitative data, quantitative data, or a combination of qualitative and quantitative data. Activity data could refer to bill payments, payment history, opening credit lines, amount owed, length of credit history, credit mix, new credit, closing credit lines, or debt repayment across at least one provider and includes at least one of performance indicator data, historical exchange settlements, and account exchange information. Furthermore, activity data may also encompass broader financial aspects such as revenue streams, expenditure patterns, asset management, liability assessments, investment portfolios, and overall fiscal strategies. Additionally, activity data may encompass real-time or near-real-time transactions, reflecting an up-to-the-minute snapshot of the user's financial status. Activity data may include, but is not limited to, employment history, income stability, education level, professional qualifications, assets (liquid and non-liquid), criminal record, character and fitness, professional reputation, fiscal responsibility, and so on. In some embodiments, the activity data may be specific to a certain activity. For example, driving records (e.g., vehicle accident reports) may be relevant activity data for a car loan and home activities (e.g., property damage) may be relevant activity data for a mortgage. “Future activity data” and “new activity data” refers to the above-defined activity data that a user may perform or take in the future.

As used herein, a “performance indicator” refers to any measurement of user/entity performance, often financially or economically related (e.g., person's borrowing practices). That is, performance indicators can illustrate whether a person is a reliable borrower (e.g., a person that makes payments on time, has a stable debt-to-income ratio, possesses a history of responsible credit use, and/or maintains a diverse mix of credit types). In some embodiments, performance indicators may involve qualitative data, quantitative data, or a combination of qualitative and quantitative data. Performance indicators may include, but are not limited to, a variety of well-established creditworthiness metrics, such as credit scores (e.g., FICO score and VantageScore), user debt-to-income (DTI) ratio, credit utilization ratio (CUR), payment history, length of credit history, credit mix, public credit records (e.g., bankruptcies, tax liens, judgements, foreclosures, etc.), and so on. In some embodiments, a performance indicator may be determined based on a plurality of performance indicators. For example, determining a credit score may involve analyzing a person's credit mix, payment history, and length of credit history. In some embodiments, the performance indicators are produced by third-parties. For example, the credit score may be produced by credit bureaus (e.g., Equifax, Experian, and TransUnion). For example, a performance indicator could refer to a credit score, credit report, debt-to-income ratio (DTI), payment history, income stability, debt utilization ratio, savings and asset levels, among other performance standards. In another example, a performance indicator could refer to net profit margin, return on investment (ROI), cash flow forecasts, equity ratios, liquidity ratios, or customer retention rates, each reflecting various aspects of a user's financial health and operational efficiency. In particular, a performance indicator can be construed as a snapshot (e.g., real-time or near real-time) or representation of the financial health of a user or account at a given point in time. It's a multidimensional concept that encapsulates various economic indicators such as the user's solvency (its ability to meet long-term obligations), assets (what it owns), liabilities (what it owes), and other related financial markers. Often, the analysis system 110 can set rules for determining a performance indicator based on activity data. For example, one type of performance indicator, the credit score is based on the activity data of amounts owed, new credit, length of credit history, payment history, credit mix, and so on. A “future performance indicator” refers to the above-defined performance indicator data that a user may correspond with at a future point in time (e.g., after activity data is received and/or monitored).

As used herein, a “performance product” refers to a financial or economic instrument. For example, a performance product can be loans (e.g., personal loans, car loans, mortgage loans), credit cards with varying interest rates and credit limits, savings accounts with differential interest rates, investment portfolios tailored to specific risk profiles, insurance policies (e.g., life, property, auto), retirement planning products, and so on. These performance products can be customized to suit an individual's financial health, based on their creditworthiness, assets, liabilities, and overall fiscal strategies. Furthermore, performance products may offer flexible terms or special offers based on one or more performance indicators of the user. As used herein, a “performance parameter” refers to provisions or terms of a financial or economic instrument that dictate its functionality, benefits, restrictions, and obligations. The performance parameters can be seen as the fine print or detailed specifications of the performance product. For example, for a loan, performance parameters could encompass interest rate, repayment period, monthly installment amount, fees, penalties for early or late payment, and other conditions or covenants. For a credit card, performance parameters may include credit limit, cashback or reward points rate, annual fees, and APR (Annual Percentage Rate). In the context of an insurance policy, it might relate to coverage limits, deductibles, premium amounts, and specific conditions or events under which a claim can be made. Performance parameters serve to define the scope, advantages, and responsibilities associated with a given performance product, allowing entities to make informed decisions about which product suits their needs best.

As used herein, a “performance parameter” refers to the provisions, terms, and minimum requirements associated with a financial or economic instrument that dictate its functionality, benefits, restrictions, and obligations. These parameters outline both the specifications of the performance product and the eligibility criteria an entity or user must meet to obtain the performance product. For example, for a loan, performance parameters could encompass interest rate, repayment period, monthly installment amount, fees, penalties for early or late payment, as well as eligibility requirements like minimum credit score, acceptable debt-to-income ratio, stable employment history, and minimum monthly or annual income. For a credit card, performance parameters may include credit limit, cashback or reward points rate, annual fees, APR (Annual Percentage Rate), and qualification metrics such as past payment history, current debt levels, and absence of recent bankruptcies. In the context of an insurance policy, performance parameters might relate to coverage limits, deductibles, premium amounts, specific conditions or events under which a claim can be made, and prerequisites like a clean driving record for auto insurance or a health assessment for life insurance.

As used herein, “actionable activity” refers to any activity that can be taken by a user in response to activity data. For example, an actionable activity can refer to making a payment, automating future payments, remediating past payments, remediating past missed payments, consolidating lines of credit, generating a reward, performing a fraud check on exchanges, generating a notification, registering a new account or line of credit, paying a minimum, or other user activities. In another example, an actionable activity can refer to initiating a financial danger assessment, tailoring personalized financial products, or restructuring existing financial arrangements in alignment with the user's current financial standing. As such, the actionable activity can be one or more activities the user or computing systems can execute or perform to reach or progress to reaching a goal, such as qualify for a performance product. In general, some or more actionable activities can be configured to attempt to improve (e.g., if executed or performed) one or more performance indicators of the user (e.g., to qualify for a performance product). It may also encompass engaging in proactive communication with the user to provide financial counseling, recommend investment strategies, or offer assistance in budget planning. It should be understood that the actionable activities can be automatically performed (e.g., in real-time, after user approval, after predefined time) by the modeler circuit 124 which can be configured to interpret and respond to various triggers and conditions within the activity data. Through a systematic integration with relevant financial systems (e.g., API integration), the modeler circuit 124 can automatically execute a range of activities such as payment processing, credit line management, detections, and customer communication, all aligned with the predefined criteria and the financial context of the user. The automated capabilities of the modeler circuit 124 can increase efficiency and responsiveness, and ensure a consistent and informed approach in handling the multifaceted financial or economic needs of the user.

As used herein, “resource allocation authorizations” refer to permissions or rights granted by one or more provider computing systems to access and utilize specific resources, guided by certain authorization parameters. These authorization parameters may define the extent and manner in which various financial systems, databases, or computational capabilities can be accessed and applied. The resource allocation authorizations may be analyzed, bundled, and modeled to generate new authorization parameters, potentially considering common or conflicting aspects across different authorizations. Accordingly, this process enables the creation of a bundled resource authorization that aligns with predefined rules or user-defined preferences, ultimately aiming to provide a positive impact on performance indicators related to the financial or economic health of a user. Additionally, the resource allocation authorizations provide a role in managing obligations, such as debt repayment, through the estimation of elimination periods and other financial strategies.

The processing circuit 114, interacting (e.g., communicating with by sending requests and/or commands/signals) with the memory 120 can store a variety of data in the modeling dataset 122, according to some embodiments, including user data structures. The modeler circuit 124 can use data stored in the modeling dataset 122 and other gathered data to generate a user data structure and performance products (e.g., including performance parameters) which could then be stored in the modeling dataset 122. The modeling dataset 122 may also be configured to store a user data structure and performance products which can include updated personal information for customer accounts associated with the provider (e.g., the FI). For example, the modeling dataset 122 can store personal user information that models account activity affecting performance indicators, such as previous exchanges for loans, bills, credit card payments, payments to other accounts either owned or not owned by the user, among other exchanges. The modeling dataset 122 can store other personal user information used in modeling activity such as name, age, gender, address, education, occupation, etc., customer preferences, such as notification preferences, security preferences, etc., and authentication information, such as customer passwords, biometric data for the customer, geometric information (e.g., latitude, longitude), etc. In some embodiments, the modeling dataset 122 can include a token vault that stores an associated customer token and/or device token for each customer account. The modeling dataset 122 may further be configured to store financial data for each customer account, such as past transactions, different provider account information (e.g., balances, debt, type of account, etc.), investments, loans, mortgages, and so on.

In some embodiments, the memory 120 and modeling dataset 122 may be communicably coupled to the modeler circuit 124, data control circuit 126, or content control circuit 128. It should be understood that “circuit” used herein can be any processing circuit(s) or computational systems designed to perform specific tasks, including but not limited to microprocessors, microcontrollers, application-specific integrated circuits (ASICs), field-programmable gate arrays (FPGAs), or any combination thereof, capable of executing the required functions and operations for handling, analyzing, and processing the activity data, performance indicators, and actionable activities as described herein. The modeler circuit 124 can implement modeling operations of the analysis system 110. In various arrangements, the modeler circuit 124 can be configured to receive a plurality of data from a plurality of data sources (e.g., memory 120, modeling dataset 122, data control circuit 126, content control circuit 128, user device 140, data source 170) via one or more data channels (e.g., over network 130). Each data channel may include a network connection (e.g., wired, wireless, cloud) between the devices or systems and the analysis system 110. For example, the modeler circuit 124 could query the memory 120 for data of the modeling dataset 122 and use the modeling data to generate a user data structure that models user activity data and one or more performance indicators (e.g., the modeling dataset that includes items such as past bills can be used by the modeler circuit 124 to create a user data structure that resembles an up-to-date credit score).

The modeler circuit 124 can be further configured to receive new activity data or an updated performance indicator from the input/output device 132 of the analysis system 110 or from the modeling dataset 122. For example, the modeler circuit 124 may be configured to continuously monitor and receive new information from a user device 140, data source 170, or provider system 135 via the network 130 and determine the effect on the one or more performance indicators. New data can affect the modeling dataset 122 and thereon after the modeler circuit 124, data control circuit 126, content control circuit 128, and other parts of the analysis system 110. For example, a user could pay off a previous debt after their activity data has already been sent to the analysis system 110. A source (e.g., user device 140, data source 170, or provider system 135) may then send the activity data, (e.g., debt payment) to the analysis system 110. Because debt payment can be a significant factor affecting the performance indicator, not only would the modeling dataset 122 be updated, but the modeler circuit 124 would update the user data structure. For example, the debt payment could cause the modeler circuit 124 to change the credit capabilities of the user, which affects what products and actionable activities are available to the user.

For example, the modeler circuit 124 can be configured to model user activity data and the one or more performance indicators to generate a user data structure. In some embodiments, the data structure created by the modeler circuit 124 corresponds to at least one past, current, and/or future activity of the user. The modeler circuit 124 can continuously update the user data structure based on continuously updating the user activity data received by the analysis system 110 from various sources (e.g., user device 140, data sources 170, or provider systems 135). Because many of the performance indicators can be proportional to changes in activity data, the modeler circuit 124 can continuously update the user data structure in response to updated user activity data. For example, if a user were to open a new line of credit, the modeler circuit 124 could determine the effect of the new line of credit has on the user data structure to determine what products the provider could offer. For example, the modeler circuit could update the user data structure and determine that the new line of credit could allow the customer to consolidate other lines of credit into the new one, consolidate bill payments into the new credit line, or simply update the user data structure to note a new line of credit and its effects on other performance indicators, among other capabilities.

In some embodiments, the modeler circuit 124 can determine that new data in the modeling dataset 122 contains a discrepancy or violation. For example, the modeling dataset 122 could receive new activity data or performance indicators including an updated economic or credit report on the user. When the modeler circuit 124 uses the updated activity data to create an updated user data structure, the modeler could flag a discrepancy in the updated activity. For example, the credit report could include a false line of credit that the previous activity data did not include. The modeler circuit 124 could then model the user activity data to create a user data structure that denotes a false line of credit to be addressed by the data control circuit 126 or content control circuit 128.

In some embodiments, the modeler circuit 124 can model activity data to determine information such as how performance indicators are affected based off the data in the memory 120 and rules on how activity data and performance indicators affect a user data structure, future activities, and performance indicators, among other. The modeler circuit 124 can be configured to perform data fusion operations, including operations to generate and/or aggregate various data structures stored in memory 120. For example, the modeler circuit 124 can be configured to aggregate data stored in memory 120, such as aggregating the total amount of lines of credit open by a user for purposes of determining if a new line of credit could be opened or if the user would benefit from consolidating lines of credit. The data may be a user data structure associated with a specific user and include various data from a plurality of data channels.

In some embodiments, the modeler circuit 124 can determine that the user data structure includes previous activity of the user causing an update in one or more performance indicators. In some embodiments, the modeler circuit can provide information to the data control circuit 126 and content control circuit 128. For example, if a user were to repeatedly pay a number of bills on time for an extended period of time, the modeler circuit 124 may determine an increase in a user's performance indicator. The modeler circuit 124 can determine through its modeling that the bill payments warrant an increase in one or more performance indicators and indicate to the data control circuit 126 or content control circuit 128 to update the GUI to present the update to the user.

In some embodiments, the modeler circuit 124 can determine, based on the data in memory 120, that a user's activity data, if altered in a future scenario, could provide an additional benefit to one or more of the performance indicators. In some embodiments, the modeler circuit 124 can identify a plurality of resource allocation authorizations associated with at least two provider computing systems (e.g., provider systems 135, data sources 170). In some embodiments, the plurality of resource allocation authorizations may correspond to at least one authorization parameter to utilize one or more resources of each of the provider systems (e.g., provider systems 135, data sources 170). In some embodiments, the modeler circuit 124 could further determine a bundled resource authorization to offer the user to be presented to the user by the data control circuit 126 or content control circuit 128. In some embodiments, the bundled resource authorization includes the modeler circuit 124 generating one or more new authorization parameters based on the authorization parameters of each of the provider systems 135. For example, the modeler circuit 124 could determine, based on data in the memory 120 that a user has lines of credit open with multiple providers or bills being paid at multiple providers. If the lines or credits or bill payments satisfy predetermined rules for configuring future activity such as offering a bundled line of credit, then the modeler circuit 124 may configure a bundling scenario and indicate to the data control circuit 126 or content control circuit 128 to update the GUI to present the scenario to the user.

In some embodiments, the modeler circuit 124 can determine one or more common parameters across the plurality of resource allocation authorizations and can determine one or more conflicting parameters across the plurality of resource allocation authorizations. In some embodiments, the modeler circuit 124 can model the one or more common parameters and the one or more conflicting parameters to generate the one or more new authorization parameters. In some embodiments, modeling includes combining one or more common parameters and resolving the one or more conflicting parameters based on a set of predefined rules or user-defined preferences. For example, if a user has lines of credit open at multiple institutions, the processing circuit 114 could combine the lines of credit together into one line. Further, the processing circuit could identify if the different institutions have conflicting parameters such as associated a different credit score with the user and resolving the discrepancy. In some embodiments, consolidating the plurality of resource allocation authorizations into the bundled resource authorization is done to provide a positive impact on the one or more performance indicators. For example, the processing circuit 114 and modeler circuit 124 may only provide a consolidation of bundled lines of credit if consolidation positively affects a user's credit score. In some embodiments, the bundled resource authorization includes an estimated elimination period for satisfying one or more obligations associated with the plurality of resource allocation authorizations. For example, the processing circuit 114 may provide for an education aspect such as providing an estimated payoff time to pay off debt from one or more of the user's credit lines.

In some embodiments, the functionalities of the modeler circuit 124 include the principles of spatial and temporal locality in relation to data access from memory 120. Specifically, when the modeler circuit 124 processes large volumes of user activity data and performance indicators, the sequence and proximity of data accesses can be efficiently organized and predicted. For example, by understanding spatial locality, when a certain activity data of a user is accessed, adjacent or related data in memory 120, such as consecutive credit transactions or related credit lines from the same institution, can be pre-fetched, anticipating further related operations. This enhances the speed and efficiency of modeling, particularly when constructing or updating the user data structure. Conversely, utilizing the principle of temporal locality, frequently accessed patterns of user behavior, like repetitive credit inquiries or regular monthly transactions, can be cached for rapid access. Given the dynamic nature of user credit data, and the need for timely updates to ensure accuracy, the modeler circuit 124 benefits greatly from these principles. When predicting or simulating future credit scenarios, or consolidating data from various sources, an effective utilization of memory access patterns directly translates to quicker modeling outputs, more accurate predictions, and a streamlined user experience.

For example, common parameters might be identified when two provider computing systems adhere to the same regulatory compliance standards, thus allowing for a unified approach to data security and access control. In this example, the modeler circuit 124 can combine these common parameters into a single set of authorization rules. Conversely, conflicting parameters may arise when different provider systems have divergent interest rates or lending criteria for lines of credit. One provider system might offer preferential rates to long-standing customers, while another provider system may base its rates on recent credit history. In such a case, the modeler circuit 124 would identify and resolve these conflicts, potentially by adopting an average interest rate or by applying predefined rules that prioritize one provider's criteria over the other. In another example involving three providers, there might exist both common and conflicting parameters within the resource allocation authorizations. For example, all three providers might adhere to a common parameter such as a standardized data encryption protocol for securing financial transactions. This commonality ensures that data integrity and security measures are uniform across all systems. However, conflicting parameters may emerge in areas such as lending policies or customer rewards programs. Provider A might offer a line of credit with a reduced interest rate for new customers, Provider B may prioritize a rewards program based on customer loyalty, while Provider C might have a hybrid approach combining both elements. In this example, the conflicting parameters represent divergent strategies for customer engagement and retention. The modeler circuit 124 would identify these conflicts and might resolve them by creating a new bundled resource authorization that attempts to balance or harmonize these different approaches. The resolution could involve a weighted scoring system that takes into account the unique offerings of each provider, creating a tailored financial product that reflects the user's particular needs and preferences.

In some embodiments, the data control circuit 126 can be configured to identify user activity data and one or more performance indicators of a user. The data control circuit 126 can parse through various financial transactions and behaviors to extract relevant activity data. This data can range from concrete financial actions such as bill payments, credit line histories, to broader aspects like professional reputation. In some embodiments, depending on its relevance to particular financial scenarios, the data control circuit 126 categorizes and prioritizes the extracted data. For example, while driving records may be relevant for assessing car loans, home-related activities are prioritized for mortgages. Additionally, the data control circuit 126 identifies performance indicators which are quantitative or qualitative metrics indicating a user's financial health. These indicators include metrics, including but not limited to FICO scores, debt-to-income ratios, and others. Each indicator, while standalone, may derive its value from various underlying data points. Furthermore, the data control circuit 126 integrates inputs from third-party entities, such as credit bureaus, consolidating external and internal data for an assessment of a user's financial health.

In some embodiments, the modeler circuit 124 can be configured to model the user activity data to generate one or more performance products including a plurality of performance parameters corresponding to a future performance indicator of the user. A performance product can range from various loans (e.g., personal, vehicle, or property loans) to credit cards and savings accounts. The performance products could also extend to tailored investment portfolios reflecting a user's risk appetite or coverage policies spanning life, property, and automobile coverage, as well as retirement planning tools. The objective of the performance products is to align them with an individual's financial profile, which encompasses their assets, creditworthiness, existing liabilities, and overarching financial plans. To ensure that these products are fine-tuned to the user's requirements, the modeler circuit 124 incorporates performance parameters. These parameters can be the terms and provisions that set the operational framework, perks, constraints, and duties of a given performance product. For example, for a loan, the parameters could be the interest rate, duration for repayment, monthly installment value, associated fees, and stipulations surrounding both early and delayed payments. Similarly, when considering credit cards, the parameters could detail out the credit threshold, potential rewards or cashback schemes, any annual fees, and the annual percentage rate (APR). Moreover, the performance parameters can also detail the prerequisites a user must satisfy to be eligible for the performance product. As an example, securing a loan might demand a certain credit score, an acceptable debt-to-income ratio, evidence of consistent employment, and a set income benchmark (e.g., all actionable events). For a credit card, the parameters might assess past payment behaviors, current debt magnitude, and any recent financial red flags like bankruptcies. An insurance policy, meanwhile, would weigh up factors like a driving record for vehicle insurance or a health check for life coverage.

In some embodiments, the content control circuit 128 can be configured to generate and present a graphical user interface (GUI) including one or more actionable events associated with the plurality of performance parameters. For example, the GUI can include a series of actionable events (e.g., specific tasks or activities that users can undertake). For example, when the user's activity data suggests they have pending bills, the actionable event may prompt them to make a payment. If a user has several upcoming payments, they might be provided with an option to automate these future payments, ensuring they're timely and avoiding any penalties. In situations where the activity data indicates missed payments from the past, the GUI could provide options for users to rectify those missteps, either by remediating past payments or by consolidating various credit lines to streamline their financial commitments. Beyond regular financial management, the GUI can also offer additional actions. If the user has been maintaining a good credit behavior, a reward generation option might pop up. Or if there is suspicious activity detected in the activity data, an actionable event could be to initiate a fraud check on particular transactions. Users might also be given alerts or notifications about certain financial behaviors, “nudging” them to take corrective or beneficial actions. Additionally, the GUI can facilitate new financial endeavors. For example, if a user wants to expand their credit horizon, options to register a new account or credit line might be presented. If there is a due on their credit card, they might get an actionable event to pay at least the minimum amount to avoid additional charges. In some embodiments, the modeler circuit 124, in conjunction with the content control circuit 128, can automate several of these actions. Based on the activity data and specific preset triggers or conditions, certain actions can be executed in real-time, post the user's approval, or after a certain predefined interval.

In some embodiments, the data control circuit 126 can be configured to monitor the user activity data and the one or more performance indicators of the user based on receiving new activity data corresponding to the future performance indicator from a user data source. In general, the data control circuit 126 can track the user's ongoing activity data, a repository of the user's financial behaviors and actions. Concurrently, it can also monitor the performance indicators linked to the user. Upon receiving new activity data, which likely projects potential future actions or behaviors of the user, the data control circuit 126 could employ data parsing algorithms to segregate incoming data, ensuring that the information pertinent to future performance indicators is extracted accurately. Post-extraction, normalization methods would be applied to standardize this data. Furthermore, the data control circuit 126 could also implement data comparison algorithms. These algorithms can compare the new activity data against existing benchmarks, thresholds, or patterns previously recorded. If anomalies or significant deviations are detected, the data control circuit 126 can flag them for further analysis or action. In some embodiments, machine learning models could also be integrated, enabling the data control circuit 126 to learn from the continuous stream of data. Over time, the data control circuit 126 can refine the accuracy and relevance of monitoring.

In some embodiments, the modeler circuit 124 can be configured to determine whether the new activity data satisfies the plurality of performance parameters of the one or more performance products. The modeler circuit 124 can implement modeling operations of the analysis system 110. In various arrangements, the modeler circuit 124 can be configured to receive user activity data and one or more performance indicators of the user from a plurality of data sources (e.g., memory 120, modeling dataset 122, data control circuit 126, content control circuit 128, user device 140, data source 170) via one or more data channels (e.g., over network 130). Each data channel may include a network connection (e.g., wired, wireless, cloud) between the devices or systems and the analysis system 110. The modeler circuit 124 then uses this data to generate one or more performance products including a plurality of performance parameters corresponding to a future performance indicator of the user.

The modeler circuit 124 can be further configured to receive new activity data or an updated performance indicator from the input/output device 132 of the analysis system 110 or from the modeling dataset 122. For example, a user could make a significant financial transaction after their initial data was received. Such new data can be conveyed to the analysis system 110. Recognizing this, the modeler circuit 124 may model the updated user activity data to potentially generate new or adjusted performance products based on the latest information. For example, a recent debt payment could influence the performance products available to the user, altering the parameters related to their future financial standing. As the modeler circuit 124 receives and processes user activity data and performance indicators, it can model this data to generate performance products tailored to the user. In certain embodiments, these performance products are for future financial behaviors or standings, anchored by parameters that correspond to past, present, and potential future activities. As data is monitored coming in, the modeler circuit 124 can track the progress of the performance parameters or update the performance products and/or parameters. A new financial action, like opening a fresh credit line, might lead the modeler circuit 124 to reassess and modify the performance products, identifying opportunities such as consolidation or highlighting changes in future financial predictions.

In general, the modeler circuit 124 utilizes the user activity data to tailor performance products distinguished by unique performance parameters. These parameters, reflecting eligibility criteria, can be user specific. They can shift in response to a user's evolving financial behaviors as evident from their user activity data. In some embodiments, the modeler circuit 124 can provide users with a clear roadmap when aiming for a specific product like a mortgage loan. This roadmap might highlight positive financial behaviors that would increase their eligibility for the desired product. In some embodiments, the modeler circuit 124 can incentivize these behaviors, offering prospective mortgage rates based on the predicted positive financial trajectories of the user. If the user's future rate appears promising, the provider may lock in a competitive rate ahead of time. In some embodiments, the modeler circuit 124 can offer rewards along the user's financial journey. These could range from points that could be used towards a mortgage to reward points for credit cards. From an educational perspective, users could be offered reward baskets that level them up in financial literacy, or tangible benefits like a free safety deposit box, bundled offers, or discounted rates on other services if certain accounts are opened. In some embodiments, the modeler circuit 124 can present the user with a clear offer: if they agree to certain conditions (e.g., performance parameters), they can accept and embark on the journey towards achieving the offer (e.g., the performance product). It can be similar to a contractual commitment, where the user is given a roadmap to a loan or other product at a future date. But, it is also made clear that even if they follow the roadmap, certain boxes must still be ticked, like maintaining a debt-free status.

For example, the modeler circuit 124 can assess an incoming college freshman's potential and offer a distinct performance product: a favorable interest rate on a home loan available four years later. This offer would apply to homes priced under $500k and comes with specific actionable events associated with performance parameters. The modeler circuit 124 can set these events to emphasize the completion of their degree, full repayment of any student debts, and diligent credit card management with no late payments. In some embodiments, the modeler circuit 124 can monitor the student's financial trajectory throughout the four years, ensuring they are on track to meet these benchmarks. Achieving these would indicate that the student's future performance indicators have been enhanced, qualifying them for the loan. This arrangement not only incentivizes the student to make sound financial decisions during college but also provides a tangible reward—a competitive home loan interest rate—that can lead to substantial savings over time. In some embodiments, the modeler circuit 124 can serve as a real-time financial tracker for the student, alerting them to positive financial milestones and any deviations that might jeopardize the home loan offer.

In some embodiments, the modeler circuit 124 can offer a range of performance products tailored to different life stages and goals. For example, a recent graduate might be presented with a car loan offer at a preferential rate if they maintain consistent employment for 12 months and save a certain percentage of their income. Meanwhile, a young family planning for their child's education might be given an offer for a specialized savings account with a higher interest rate if they commit to monthly contributions and enroll in financial literacy workshops. For retirees, the modeler circuit 124 could propose a travel rewards credit card with waived fees if they consistently maintain a minimum balance in their retirement account. In some embodiments, while the actionable events act as guiding benchmarks, the final determinant of qualification can remain with satisfying the performance parameters corresponding with a future performance indicator. Nonetheless, events are generated to channel user behaviors towards achieving an optimal future performance indicator to satisfy performance parameters of the performance product. However, despite meeting these events, it is the eventual performance indicator that may officially qualify or disqualify an individual for the proposed performance product.

In some embodiments, the content control circuit 128 can be configured to present one or more content items on the GUI including an indication of whether the user satisfies the one or more actionable events of the one or more performance products. This indication could be manifested as a progress bar or a series of checkboxes corresponding to each actionable events. As users meet individual events, specific portions of the progress bar could fill or checkboxes could be ticked, providing a visual representation of their accomplishments. Once a user satisfies all the set performance events, a distinct indication, such as a highlighted badge, a color shift, or a congratulatory message, could be displayed, signifying the completion of all criteria.

In some embodiments, the processing circuit 114 can monitor the one or more performance indicators (and user activity data) based on continuously receiving new information from a user device of the user (e.g., user device 140), one or more data sources (e.g., data source 170), and one or more provider systems (e.g., provider system 135). For example, the processor can determine a user plan based on the user activity data, such as a plan aimed to increase a credit score. The processing circuit 114 will then continuously monitor user activity relating to the plan, and the modeler circuit 124 can continuously monitor user activity to update the user data structure (sometimes referred to herein as the “user activity data”, where the “user activity data” that is old, new, or in the future is stored and updated). In some embodiments, the processing circuit 114 can determine a discrepancy in the user activity data or performance indicators based on previous activity of the user. For example, a credit report could include a line of credit that the customer did not have. In some embodiments, the processing circuit 114 can determine a violation associated with the actionable activity based on a comparison between user activity data or a performance indicator and a desired action for increasing the performance indicator. In some embodiments, the comparison identifies an activity that is counter to the desired action. For example, the user may pay a bill late after having a plan to increase their credit score. In some embodiments, the processing circuit 114, through the data control circuit 126 or content control circuit 128, can remediate the discrepancy or violation by at least one of two methods: presenting an alert on the GUI including remediation instructions for the user, or establishing, via an alert on the GUI, a communication session with an external system associated with the counteractivity to the desired action. In some embodiments, the processing circuit can additionally update the external system to remove or update the counteractivity to the desired action or initiating an exchange between an account of the user and the external system. For example, in response to the bill being paid late, the system could contact the company that allowed the payment to be made late, contact a credit card company to close a new account, or initiate a payment transaction to address a late payment, among other responses. In another example, if the processing circuit 114 detects a late payment that contradicts the entity's or user's plan to improve their credit score, the processing circuit 114 may automatically initiate the payment transaction to the external system associated with the bill. This corrective action (e.g., done after obtaining the user's consent, done automatically without user's consent), not only addresses the late payment but also sends a request to update the credit reporting information, mitigating the potential negative impact on the entity's or user's performance indicator(s).

In some embodiments, the processing circuit 114 and modeler circuit 124 can determine one or more characteristics of the user data structure causing the update to the one or more performance indicators and generate a plan associated with at least one different characteristic to cause an increase to the one or more performance indicators. In some embodiments, in response to the user performing at least one different characteristic, the processing circuit 114, through the content control circuit 128, can provide and present a reward in the GUI. In some embodiments, the reward enables another feature of the GUI. For example, the processing circuit 114 can identify financial behavior of a user such as their habits for budgeting, saving, investing, spending habits, debt management, financial goal setting, financial planning, tracking expenses, risk management, or financial education, among other habits. For example, the processor can determine when the user is more likely to miss a bill payment and can further generate a plan such as adding funds to a bill payment pool in order to pay all bills on time and further increase credit. After implementing the plan and the user no longer misses bill payments, the processor 116 and content control circuit 128 can provide a reward to the user through the I/O device 132. For example, if the user follows the plan to no longer miss any payments, the reward may be access to additional financial products of the bank. Financial products of a bank could include updated or more favorable accounts, certificates of deposits, loans, credit cards, debit cards, investment services, insurance products, foreign exchange services, and online or mobile banking services, among other products.

In some cases, the modeler circuit 124 may analyze the user's historical payment data, spending habits, and current financial situation to predict that the user or entity is likely to miss an upcoming bill payment, and this prediction could be based on a trend showing consistent late payments or depletion of funds in the associated account before the payment due date. This analysis may lead to the generation of a targeted alert or recommendation, encouraging the user or entity to take corrective action such as rescheduling payments or reallocating funds. In response to predicting a likely missed payment, the modeler circuit 124 could also present an offer (e.g., and sometimes automatically accept the offer without user or entity interaction) for a one-time financial product specifically tailored to help the user or entity avoid missing the payment, such as a short-term loan with favorable terms or a temporary increase in the overdraft limit. This offer could be made through the GUI, providing the user or entity with detailed information about the product, its benefits, and an option to accept the offer immediately, thereby giving the user or entity an opportunity to make the bill payment on time without negatively affecting their performance indicator or incurring late fees.

In some embodiments, the processing circuit 114 can perform an analysis check on previous activities of the user. For example, in some embodiments, the modeler circuit 124, data control circuit 126, or content control circuit 128 could run a security verification on any previous activity received from a user device 140, data source 170, or provider system 135 via the network 130. In some embodiments, the security verification can create a security profile corresponding to any previous activity, based on factors such as origin, transaction type, transaction location, transaction amount, and more. In some embodiments, actions that depend on the security profile of previous activities are triggered by a security threshold. According to some embodiments, previous activities are inconsistent with previous user activity data can trigger actionable events. For example, in some embodiments, when a security profile is below a security threshold, the data control circuit 126 could send instructions to the content control circuit 128 that includes sending a GUI to the user device 140 with an actionable element and at least one message associated with the triggering data. In particular, if a large and unexpected transaction from a foreign location is detected, and it falls below (or above, depending on how the threshold is set) the established security threshold, the data control circuit 126 might prompt the content control circuit 128 to send a notification to the user's mobile device through the GUI, asking them to confirm or deny the transaction.

In some embodiments, the processing circuit 114 can determine that at least one previous activity is a fraudulent activity within the user activity data and automatically remove the fraudulent activity from the user activity data. In some embodiments, the modeler circuit 124 can additionally remodel the activity data and the one or more performance indicators to generate an updated user data structure. For example, the processing circuit 114 can determine if one of a user's previous transactions was a transaction from the user's stolen credit card. Removing this stolen transaction from the user's data set and remodeling the user data structure can provide for a more accurate depiction of a user's spending habits or other performance indicators.

In some embodiments, at least one future activity of the user can be associated with a statement settlement action. In some embodiments, the processing circuit 114 or more specifically the modeler circuit can determine the statement settlement action will cause a negative account balance associated with an account of the user. In some embodiments, the processing circuit 114 can update an automatic exchange associated with the statement settlement to cause the non-negative account balance associated with the account of the user and configure a different statement settlement action to satisfy the difference between the non-negative account balance and the negative account balance. For example, through the modeling, the system can determine if the user has, or is likely to have a future bill payment. If the system determines the bill will result in a negative account balance (e.g., overdraft), the system can automatically setup another action, such as payment with a different account or payment with a credit card, among other actions, to remediate the negative balance. In some embodiments, the future activity can include a future exchange event associated with the user, and the future exchange event can cause a change in the user data structure, and in response to a selection of at least one actionable element, the future exchange is automated based on configuring an automatic exchange between a user's account and an external system. For example, the future exchange event could be a bill pay, which could affect the user data structure such as the account balance for the user. If the actionable element of the GUI is to set up a future automatic payment for one or more bills, if the user accepts, then the system can automatically pay the future bills, even if the future bills are occurring through an external system, such as at another FI.

In some embodiments, the data control circuit 126 can be configured to perform data fusion operations, including operations to generate various data structures stored in memory 120 and used by the various circuits described herein. For example, the data manager can communicate with the user device or data sources by collecting, receiving, or identifying data relevant for use by the other circuits. The data control circuit 126 can also be configured to receive a plurality of entity data. In some arrangements, the data control circuit 126 can be configured to receive data regarding the network 130 as a whole instead of data specific to a particular entity. The received data that the data control circuit 126 receives can be data that analysis system 110 aggregates and/or data that the analysis system 110 receives from the data sources 170 and/or any other system described herein (e.g., provider system 135, user device 140).

The content control circuit 128 can include circuitry for storing information such as rules for offering actionable activities for customized user data structures. The content control circuit 128 can receive data for determining or displaying actionable activities to the user from any component of the activity modeler architecture 100 (e.g., receives a future action from the modeler circuit 124 affecting a performance indicator). The content control circuit 128 may additionally store this information in memory 120. In some embodiments, the content control circuit 128 can generate content for displaying to users. The content can be selected from various resources (e.g., an update for a performance indicator sent from the data control circuit 126). The content control circuit 128 can also be structured to provide content (e.g., via a graphical user interface (GUI)) to the user device 140 over the network 130, for display within the resources. For example, the content control circuit 128 can present a GUI including actionable elements and a message associated with the actionable activity that may affect the performance indicator. The GUI can be sent via the I/O device 132 to the user device 140 through the network 130.

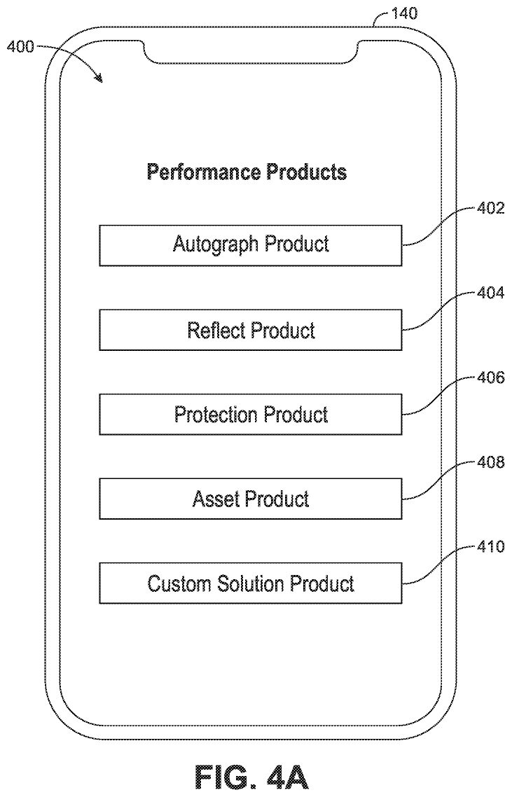

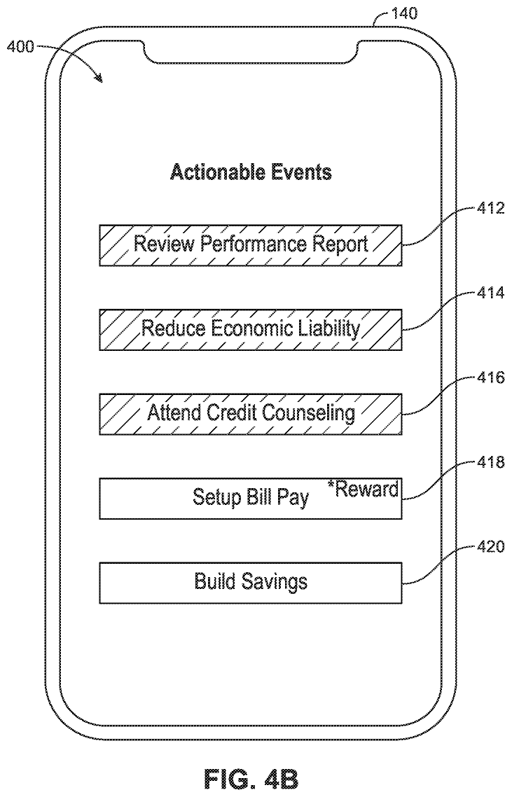

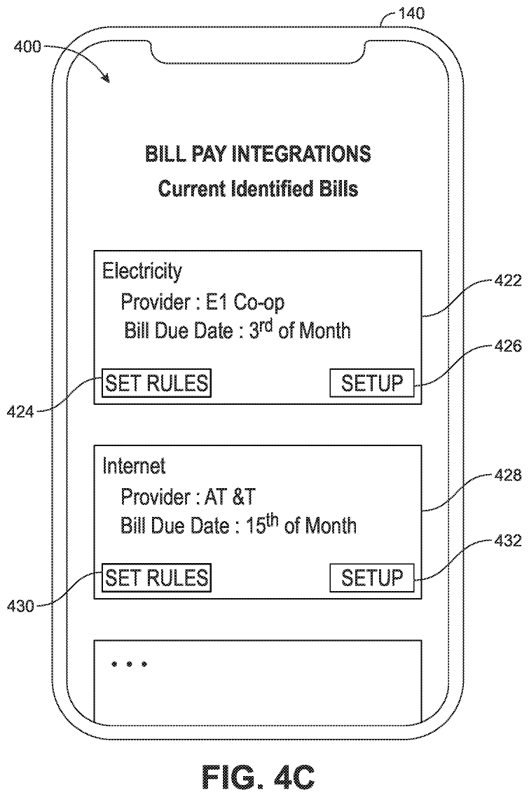

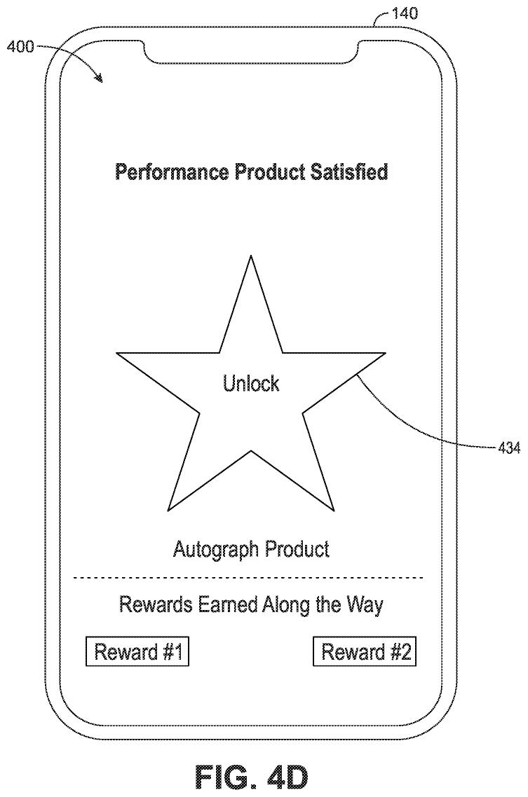

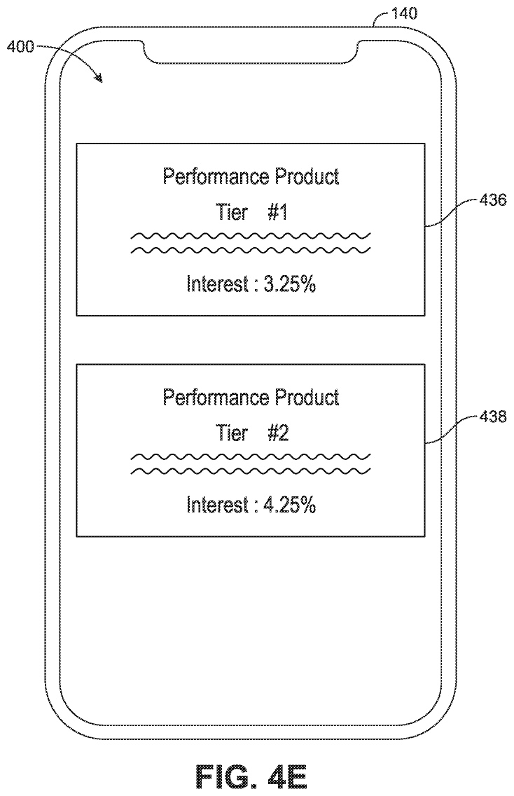

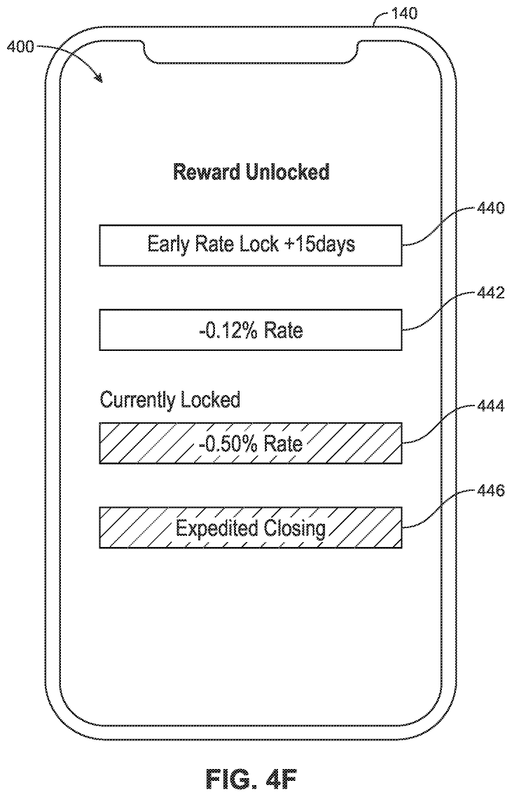

The content control circuit 128 can generate interfaces such as a plurality of customized dashboards, such as those described in detail below, with reference to FIGS. 4A-4F. The content control circuit 128 can generate customized user-interactive dashboards for one or more users, such as the user device 140, based on data received from the user device 140, data source 170, and/or any other computing device described therein. The generated dashboards can include various data (e.g., data stored in the content control circuit 128 and/or modeling dataset 122) associated with one or more entities such as actionable events, performance products, performance parameters, actionable events, a user data structure, performance indicators, past, current, or future exchange history, account information, multidimensional scores, actionable activities/executables, and/or others. In certain embodiments, the analysis system 110 includes an application programming interface (API) and/or a software development kit (SDK) that facilitate the integration of other applications with the analysis system 110. For example, the analysis system 110 is configured to utilize the functionality of the user device 140 interacting with the user client application 154 through an API.

Still referring to FIG. 1, the input/output device 132 is structured to receive communications from and provide communications to users associated with the analysis system 110. The input/output device 132 is structured to exchange data, communications, instructions, etc., with an input/output component of the analysis system 110. In one embodiment, the input/output device 132 includes communication circuitry for facilitating the exchange of data, values, messages, and the like between the input/output device 132 and the components of the analysis system 110. In yet another embodiment, the input/output device 132 includes machine-readable media for facilitating the exchange of information between the input/output device and the components of the analysis system 110. In yet another embodiment, the input/output device 132 includes any combination of hardware components, communication circuitry, and machine-readable media.

In some embodiments, the input/output device 132 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output device 132 may provide an interface for the user to interact with various applications stored on the analysis system 110. For example, the input/output device 132 may include a keyboard, a keypad, a mouse, joystick, a touch screen, a microphone, a biometric device, a virtual reality headset, smart glasses, smart headsets, and the like. As another example, input/output device 132, may include, but is not limited to, a television monitor, a computer monitor, a printer, a facsimile, a speaker, and so on. As used herein, virtual reality, augmented reality, and mixed reality may each be used interchangeably, yet refer to any kind of extended reality, including virtual reality, augmented reality, and mixed reality.

The user devices 140 may each similarly include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the analysis system 110. Therefore, it should be understood that the description of the network interface 112, the processing circuit 114, and the input/output device 132 of the analysis system 110 provided above may be similarly applied to the network interface 142, the processing circuit 144, and the input/output device 160 of each of the user devices 140.

In some embodiments, the network interface 142 is similarly structured and used to establish connections with other computing systems (e.g., the analysis system 110, other user devices 140, and data sources 170) via the network 130. The network interface 142 may further include any or all of the components discussed above, with reference to the network interface 112. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150 (e.g., user device dataset 152). For example, the user devices 140 may be configured to run an application such as the user client application 154 that is stored in the user device dataset 152. In another example, the user devices 140 may be configured to store various user data, such as, but not limited to, personal user device information (e.g., names, addresses, phone numbers, contacts, call logs, installed applications, and so on), user device authentication information (e.g., username/password combinations, device authentication tokens, security question answers, unique client identifiers, biometric data (such as digital representations of biometrics), geographic data, social media data, application specific data, and so on), and user device provider information (e.g., token information, account numbers, account balances, available credit, credit history, exchange histories, and so on) relating to the various accounts.

Particularly, the user client application 154 can be configured to communicate with the analysis system 110. As such, the user devices 140 can be communicably coupled to the analysis system 110 (e.g., through interactions with the modeler circuit 124, data control circuit 126, and content control circuit 128), and data sources 170. The user client application 154 may therefore communicate with the analysis system 110 and data sources 170 to perform a variety of functions. For example, the user client application 154 is similarly configured to receive user inputs (e.g., via a user interface of the user device 140) to complete interactions during a communication session with analysis system 110. For example, the user client application may be used during a communication session via an API with the analysis system 110 to provide performance parameter indications using content items. Additionally, the user client application 154 is configured to output information to a display of user device 140 regarding information received from the analysis system 110. For example, the user client application 154 is configured to communicate with a user interface to show graphics regarding modeled performance products with one or more actionable events. Further, a user response to a display of user device 140 regarding information from the analysis system can send a message, task, or instruction to the analysis system 110 via the network 130 that allows for the modeling dataset 122, modeler circuit 124, data control circuit 126, and/or content control circuit 138 to be perform an update.

The user client application 154 is further configured to communicate with the analysis system 110 to allow a user (e.g., of an entity or company) associated with the various user devices 140 to update account information and/or provide feedback during a communication session based on content from the modeler circuit 124, data control circuit 126, or content control circuit 128 via the input/output device 132. The user client application 154 may also be structured to allow the user devices 140 to retrieve and submit documents, forms, account information for other providers, and/or any type of necessary information to and/or from the analysis system 110 during an established session, as required to complete a communication session for a performance indicator-based analysis. In some embodiments, the user client application 154 may be configured to temporarily store the various documents, forms, and/or necessary information, which may then be selectively transmitted to the analysis system 110 in response to a user input (e.g., received via the input/output device 160).

The input/output device 160 of each user device 140 may function substantially similar to and include the same or similar components as the input/output device 132 previously described, with reference to the analysis system 110. As such, it should be understood that the description of the input/output device 132 provided above may also be applied to the input/output device 160 of each of the user devices 140. In some embodiments, the input/output device 160 of each user device 140 is similarly structured to receive communications from and provide communications to a user associated the user device 140.

The data sources 170 can provide data to the analysis system 110 and/or user device 140. In some arrangements, the data sources 170 can be structured to collect data from other devices on network 130 (e.g., user devices 140 and/or other third-party devices) and relay the collected data to the analysis system 110 and/or user device 140. In some embodiments, the analysis system 110 may request data associated with specific data stored in the data source (e.g., data sources 170). For example, in some arrangements, the data sources 170 can support a search or discovery engine for Internet-connected devices. The search or discovery engine may provide data from other providers that, when added to a user data structure (e.g., user data structure created by the modeler circuit 124 based on data from the modeling dataset 122) will cause an update to a performance indicator.

In some embodiments, the activity modeler architecture 100 can include provider systems 135. A provider system 135 can be communicated with to obtain or access additional activity data, where the provider system 135 can be banks or other credit issuers (e.g., credit card companies, consumer reporting companies, financial institutions (FI)). In some arrangements, provider systems 135 can provide data to the analysis system 110 and/or user device 140. In some arrangements, a provider system 135 can be structured to collect data from other devices on the network 130 (e.g., user devices 140 and/or other third-party devices) and relay the collected data to the analysis system 110 and/or user device 140. In some embodiments the analysis system 110 may request data associated with specific data stored in the provider system 135. For example, in some arrangements, the provider systems 135 can support a search or discovery engine for Internet-connected devices. The search or discovery engine may provide data from other providers that, when added to a user data structure (e.g., a user data structure created by the modeler circuit 124 based on data from the modeling dataset 122), will cause an update to a performance indicator.

In some embodiments, the provider system 135 can serve as a basis for the analysis system 110 to provide resource allocation authorizations. For example, a provider system (e.g., provider system 135) can provide user activity data to the analysis system 110. The processing circuit 114 can produce resource allocation authorizations based on data provided by the provider system 135. For example, the analysis system 110 could determine, based on data sent from the provider system 135, that a user is eligible for a line of credit or bundled credit system. The analysis system 110 could produce a bundled resource authorization that includes new authorization parameters based on the authorization parameters of the provider systems 135.

In some arrangements, resource allocation authorizations are configured permissions by the provider system 135, delineating access to particular financial resources such as credit lines or loans. These authorizations can be defined by detailed parameters such as credit limits, interest rates, repayment terms, or eligibility criteria. Bundled resource authorizations provide a consolidation or combination of various individual authorizations, potentially from different provider systems, and include an alignment of their respective authorization parameters. By leveraging data received from provider systems 135, the analysis system 110 can algorithmically determine a user's eligibility for a line of credit or a bundled credit system, and accordingly, formulate a bundled resource authorization. This process involves an analysis of common and conflicting parameters among the provider systems 135, and generating new authorization parameters that represent an optimized, unified authorization. For example, if the authorization parameters from two different providers allow for a certain credit limit but differ in interest rates, the bundled resource authorization might blend these conflicting parameters to offer a consolidated line of credit with a newly calculated interest rate, in alignment with predefined rules or user preferences.

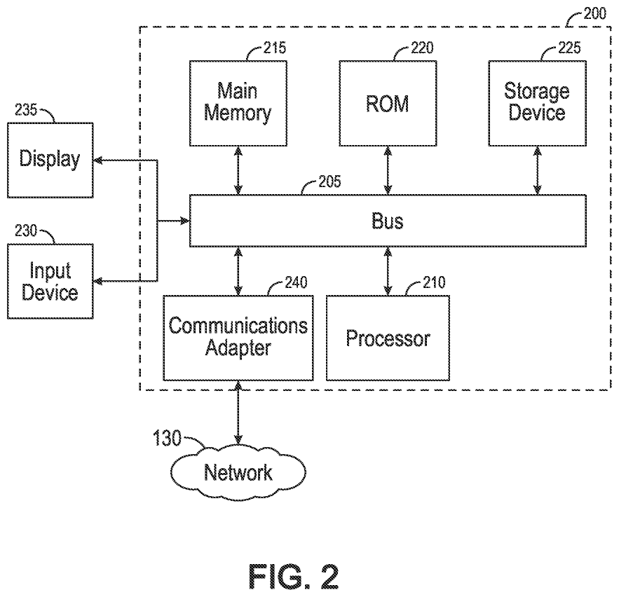

Referring now to FIG. 2, a depiction of a computer system 200 is shown. The computer system 200 that can be used, for example, to implement an activity modeler architecture 100, an analysis system 110, provider systems 135, user devices 140, data sources 170, and/or various other example systems are described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with a computing or communications network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate the illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage mediums for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

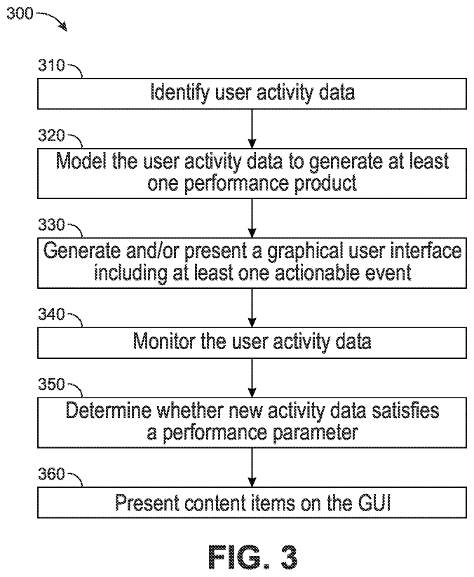

Referring now to FIG. 3, a flowchart for a method 300 of modeling the activities and performance of a user to generate performance products is shown, according to some embodiments. Analysis system 110 can be configured to perform method 300. Further, any computing device described herein can be configured to perform method 300.

In broad overview of method 300, at block 310, the one or more processing circuits (e.g., analysis system 110 in FIG. 1) can identify user activity data. At block 320, the one or more processing circuits can model user activity data and the performance indicators to generate at least one performance product. At block 330, the one or more processing circuits can generate and/or present a graphical user interface (GUI) including at least one actionable event. At block 340, the one or more processing circuits can monitor the user activity data. At block 350, the one or more processing circuits can determine whether new activity data satisfies a performance parameter. At block 360, the one or more processing circuits can present content items on the GUI. Additional, fewer, or different operations may be performed depending on the particular arrangement. In some embodiments, some or all operations of method 300 may be performed by one or more processors executing on one or more computing devices, systems, or servers. In various embodiments, each operation may be re-ordered, added, removed, or repeated.

The GUI of method 300 may be provided by and/or accessible by the user client application 154 and content control circuit 128, for example. The method 300 may be performed by the analysis system 110 or the user device 140, described above pertaining to FIGS. 1 & 2. In some embodiments, method 300 begins in response to receiving, by a user device (e.g., user device 140), through a user client application (e.g., user client application 154), data from a dataset (e.g., user device dataset 152). The data can include user data, such as historical exchange settlements, performance indicator data, performance product information, actionable events, performance parameters, and activity data. In some embodiments, method begins when the analysis system 110 receives data via the network 130 or identifies data (e.g., locally or externally).

Referring now to FIG. 3 in more detail at block 310, the one or more processing circuits can identify user activity data and one or more performance indicators of a user. In some embodiments, the user activity data can refer to any and all activity of the user that might be associated with economic actions. In general, the economic actions can be broadly categorized into three types: transactional, behavioral, and informational. In some embodiments, transactional data includes, but is not limited to, all the exchanges/transactions made by the user, such as purchases, payments, fund transfers, deposits, withdrawals, etc., carried out through various channels like banking apps, credit cards, digital wallets, or other forms of online and offline transactions. This also includes transaction frequency, transaction volume, the variety of transactions, the consistency of such transactions over a period of time, etc. In some embodiments, behavioral data includes, but is not limited to, the user's interaction with financial tools and platforms. For example, how frequently the user checks their account balance, the frequency and type of inquiries about financial products or services, the response time to financial notifications, the time spent on financial educational content, etc. In some embodiments, the informational data includes, but is not limited to, the user's personal and professional details, such as age, income, occupation, education, geographical location, marital status, number of dependents, etc.

In some embodiments, the performance indicators of a user are associated with the creditworthiness of the user. This can be determined by the one or more processing circuits through various metrics such as credit score, credit history, debt-to-income ratio, and so on. In particular, a performance indicator can be a numerical expression based on a level analysis of a person's credit files, representing the creditworthiness of an individual. Related scores (e.g., additional performance indicators) could include alternative credit scores, which can be identified or calculated using non-traditional data like utility bill payments, rental payments, or social media activity. Additionally, performance indicators can include a bankruptcy risk score, which predicts the probability of a user declaring bankruptcy, and a fraud score, which indicates the likelihood of a user committing fraudulent activity.

In some embodiments, alternatives to traditional credit scores may be used as performance indicators to provide a more comprehensive and nuanced understanding of a user's financial standing. These alternatives can incorporate unconventional data and behavior patterns that might not be reflected in a standard credit score. For example, performance indicators could include an employment stability score, assessing the consistency and longevity of a user's employment history; a financial behavior score, based on spending habits, savings, and investment decisions; or a social responsibility score, reflecting a user's commitments to charitable donations or community engagement. Additionally, a payment consistency score might be used, tracking the regularity and punctuality of payments across various obligations such as subscriptions, memberships, or informal debt agreements. An interest rate change score might also be utilized, which evaluates the user's responsiveness and adaptability to fluctuations in interest rates, potentially influencing their ability to manage loans and credit lines. These alternative performance indicators can offer a perspective on the user's financial reliability, potentially benefitting individuals who may be disadvantaged by traditional credit scoring methods.

Still referring to block 310, the process of identifying user activity data and performance indicators can encompass data acquisition, data cleaning, and data classification, executed by the processing circuits. It should be understood one or more of the described steps could be skipped or altered based on the received data. In some embodiments, identifying can include data acquisition by collecting raw data from various sources (e.g., user devices 140, data sources 170, provider systems 135). For example, transactional data can be acquired from providing systems 135 that record the transactions made by the user. Behavioral data can be collected from digital platforms like banking apps or websites (e.g., data sources 170) where the user's interactions are tracked. Informational data can be obtained from user profiles in provider systems 135, or sometimes directly from users via an application of the user device 140. Performance indicators can be sourced from provider systems 135 (e.g., credit bureaus) that provide credit scores, credit histories, and other related metrics. Alternative data sources such as utility companies or social media platforms might also be used for alternative performance indicators.

In some embodiments, once the raw data is acquired, the processing circuits can clean and prepare the data for modeling (e.g., block 320). The processing circuits can clean or scrub the raw data by executing a series of actions to detect and rectify errors, inconsistencies, and inaccuracies within the data. In particular, cleaning could include handling missing or incomplete data, correcting inaccuracies, identifying and filtering outliers, and standardizing data formats. For example, transactional data sourced from different banks might be in different formats or currencies and would need to be standardized. In another example, data cleaning may include ensuring that credit scores from different credit bureaus are comparable by aligning them to a standard scale. In some embodiments, data cleaning can include addressing discrepancies in informational data. For example, if a user has multiple accounts across different banks or financial institutions, they might have provided slightly different personal information in each account, like different phone numbers or addresses. In such cases, the processing circuits can identify these discrepancies, verify the correct information, and standardize the user's personal information across all data sources. In another example, cleaning the behavioral data might involve filtering out irrelevant or misleading activities. In this example, a user might have accidentally clicked on a financial product or service multiple times without any real intention of using it. These accidental clicks could skew the user's behavioral profile and lead to inaccurate analyses. Therefore, the processing circuits could identify such anomalies and filter them out, ensuring the behavioral data accurately represents the user's genuine financial behavior and interests.

In some embodiments, the processing circuits can execute data classification to organize the cleaned data into predefined (or new) categories based on certain criteria. Data classification can include tagging and categorizing the data points to facilitate their storage, retrieval, and analysis. Each data point may be labeled with metadata that describes its attributes, such as its source, type, and other characteristics. For example, transactional data might be classified based on the type of transaction (e.g., a purchase, deposit, or withdrawal), the method used (e.g., credit card, debit card, or bank transfer), and the sector or category of expenditure (e.g., groceries, utilities, or entertainment). The other activity data, such as performance indicators, could be classified based on the type of score (e.g., credit score, bankruptcy risk score, or fraud score) and the source of the score (e.g., which credit bureau it came from). The other activity data might also factor in performance indicators that are not score-based, such as a record of consistent home ownership, frequency of major financial transactions, or the length and stability of banking relationships. In some embodiments, the processing circuits can classify behavioral data based on the user's interactions with different financial platforms or tools. For example, data related to the user's use of a banking app could be classified based on actions such as checking account balance, making transactions, reading financial advice, or setting budgeting goals. These actions can further be classified based on attributes like frequency, duration, and time of activity. In another example, informational data could be classified based on demographic or socio-economic factors. This may include attributes such as age, income level, education, employment status, geographical location, and so on. For example, income data can be classified into different income brackets, education data can be classified based on the highest degree obtained, and geographical data can be classified by city, state, or country.

At block 320, the one or more processing circuits can model the user activity data to generate one or more performance products (e.g., loan or credit product or economic instrument) including a plurality of performance parameters (e.g., product or instrument terms) corresponding to a future performance indicator (e.g., future credit score) of the user. In some embodiments, the process of modeling can include using techniques such as machine learning, statistical analysis, and pattern recognition to establish relationships between different data points and generate performance products based on those relationships and a future performance indicator. In some embodiments, modeling can begin with the selection of an appropriate model based on the type of data and the specific predictions that need to be made. In some embodiments, the processing circuits can utilize pattern recognition methodologies to identify trends and likelihoods of desiring one or more performance products. For example, pattern recognition applied to user activity data can discern cyclical trends in expenditure, identifying increases at the beginning and middle of the month with a decline towards the end. By integrating this trend with performance indicators, like credit scores, the processing circuits can generate a performance product (e.g., short-term loan at the beginning of the month). In another example, spectral analysis can be utilized to analyze the frequency components embedded within a user's transaction history. In yet another example, linear regression models might be selected by the processing circuits for predicting continuous outcomes such as the amount a user might spend on their credit card, while logistic regression models might be selected for predicting binary outcomes such as whether a user will make a car loan payment on time or not. It should be understood that the term modeling herein encompasses a wide range of techniques and approaches aimed at understanding patterns within data and generating performance products including performance parameters. This could include anything from statistical methods and rule-based systems to machine learning algorithms, depending on the nature of the data and the specific predictions to be made by the processing circuits. Thus, modeling involves selecting techniques based on the specific characteristics of the data, ensuring that the chosen method or methods accurately captures patterns, predicts user activities, and generates desirable performance products.

In some embodiments, the model parameters can be trained and optimized using the cleaned, classified, and linked user activity data and performance indicators. This training process can include using algorithms to adjust the model parameters such that the error between the model's predictions and the actual outcomes is minimized. The modeling process can also include feature engineering, which is the process of creating new features or modifying existing ones to improve the model's predictive power. For example, instead of using raw transaction amounts, a feature representing the average transaction amount over a certain period might be more predictive of a user's future economic activity.

Once one or more models or techniques are trained and/or optimized, the processing circuits can use the model to generate a performance product including performance parameters corresponding to a future performance indicator. This performance product could take the form of a detailed loan offer, credit card limit, or investment opportunity that, while currently out of reach based on the user's existing performance indicator (e.g., current credit score), would become accessible upon achieving the projected future performance indicator. For example, if a user demonstrates a pattern of steadily increasing savings, they might be offered a higher-tier investment opportunity, provided they continue on this financial trajectory and meet specified performance parameters over a given period. Similarly, a user who shows consistent monthly expenditure reductions might be presented with a performance product like a premium credit card with enhanced benefits, contingent upon them maintaining this financial behavior and meeting other criteria. If a user is seen to be inching towards a debt-free status, a home loan offer with favorable terms might be proposed, hinging on the condition that they fully clear their existing debts within a stipulated timeframe. The essence is that while the performance products generated are aspirational and currently (or sometimes not desirable) beyond the user's immediate qualification, they are structured to become attainable as the user progresses and satisfies the defined performance parameters, aligning with the user's anticipated future financial standing.

In another example, consider a husband and wife, currently renting an apartment, with credit scores of 620 and 650, respectively. Recognizing their shared aspirations of homeownership, the processing circuits can use modeling to offer them a performance product: a mortgage of up to $750,000 at an interest rate of 5.00% (and other performance parameters). Though their current credit scores would not immediately qualify them for this attractive mortgage deal, the offer comes with a set of actionable performance parameters. If, over the next 24 months, the couple clears all outstanding debts, maintains consistent and on-time credit card payments, and meets other specific financial behaviors, it's predicted their credit scores will rise to approximately 692 and 735 for the husband and wife, respectively. Upon achieving these future performance indicators, they would qualify for the previously-offered mortgage terms. This approach not only provides a clear financial roadmap for the couple but also a tangible and aspirational goal, potentially motivating them to adopt financial behaviors that align with their homeownership dreams.

In yet another example, the processing circuits could provide a tiered system within the performance product to further incentivize positive financial behaviors. For example, if over the 24-month period, the couple manages to elevate their combined credit scores to an average of 700, they qualify for a sub-performance product offering a 5.25% interest rate on the mortgage. However, if they surpass expectations, achieving an average score of 725 or higher, a superior sub-performance product is activated, presenting them with a more favorable 4.75% interest rate. Each tier, or sub-performance product, has its specific set of performance parameters, with many overlapping requirements but differing in certain criteria intensity. This tiered approach offers flexibility and encourages individuals to exceed the minimum performance parameters for even better terms, creating a gradient of aspirational targets.

In some embodiments, the one or more performance products include a plurality of sub-performance products associated with tiers of performance, and wherein at least one of the plurality of sub-performance products correspond to at least one update to the plurality of performance parameters and at least one update to the one or more actionable events. This tiered structure allows users to progress through varying levels of financial offerings based on their adherence to performance parameters. As users meet or exceed certain criteria (e.g., by performing actionable events), they can unlock superior sub-performance products, each tailored to their evolving financial behaviors and potential. For example, a provider might offer a tiered personal loan product where, if a user's future performance indicator reaches a credit score of 680, they qualify for a $10,000 loan at a 6% interest rate, but if the score surpasses 720, the sub-performance product available includes a $15,000 loan at a 4.5% interest rate, coupled with a performance parameter requiring a slightly higher monthly income. In another example, a provider might offer a tiered rewards card where, if a user's future performance indicator reaches a credit score of 660, they qualify for a card with a $5,000 limit and 1% cash back on all purchases. However, if the score climbs to 710, the sub-performance product available is a premium version of the card with a $10,000 limit, 2% cash back, and an added performance parameter of a waived annual fee for the first year.

In some embodiments, the tiers of performance can include (1) a first tier of a first sub-performance product of the plurality of sub-performance products corresponding to an updated plurality of performance parameters and an updated one or more actionable events, and (2) a second tier of a second sub-performance product of the plurality of sub-performance products corresponding to the plurality of performance parameters and the one or more actionable events, and wherein the plurality of performance parameters increases at least one economic attribute of the user compared to the updated plurality of performance parameters. Actionable events refer to specific tasks or objectives that the user can achieve, such as maintaining on-time payments for a year or reducing the utilization rate of existing credit lines. In some embodiments, the actionable events can range from straightforward actions, such as maintaining on-time payments for a consecutive period, to more involved strategies like actively working to reduce the utilization rate of existing credit lines. These actionable events not only help in bettering a user's financial habits but also align with the lender's criteria for offering better terms. In some embodiments, an updated performance parameter, like a higher interest rate, can correspond to a compensatory measure for the perceived economic risk, possibly associated with a lower credit score. This means that if a user's current financial standing doesn't meet the ideal criteria (or a future performance indicator does not meet the criteria), they might still access the financial product, albeit at a less favorable rate. In some embodiments, achieving certain tiers may enhance the economic attributes available to the user, like securing a credit card with a lower interest rate or being granted a mortgage with a reduced down payment requirement. For example, as a user progresses in their financial journey, adhering to actionable events, they might be presented with a lower interest rate or a reduced down payment requirement for a mortgage. Such improvements not only represent a reward for the user's financial diligence but also signify their elevated financial stature, making them more appealing borrowers in the eyes of potential lenders.

In some embodiments, the processing circuits can use rule-based systems to model the user activity data. Rule-based systems can be where predefined rules are created by the processing circuits (or domain experts) to infer outcomes based on given conditions. For example, if a user consistently makes credit card payments in full before the due date, a rule might state that the user is likely to do the same in the future. This rule can then be applied to the user's data to generate a performance product with performance parameters. In some embodiments, the processing circuits can use statistical methods for modeling. This can involve approaches like time series analysis or trend analysis. For example, time series analysis can be used to identify patterns in the user's past activity data, such as seasonal trends, cyclical patterns, or overall growth trends. If a user consistently increases their credit card spending during the holiday season, time series analysis can identify this pattern and predict a similar increase for the next holiday season. Trend analysis, on the other hand, can be used to identify long-term changes in the user's activity data (e.g., for predict a future performance indicator). For example, if the user's credit score has been steadily improving over several years, trend analysis can project this trend into the future and predict a continued improvement in the credit score (e.g., stored within the user data structure).

Accordingly, the processing circuits can use a predictive modeling approach to generate performance products for a user. Additionally, the modeling approach operates agnostically of the financial institution providing the service, offering an integrated and full view of a user's financial commitments. Furthermore, the predictive modeling approach executed by the processing circuits can detect seasonal or event-based patterns in the user's spending and behaviors (sometimes referred to herein as “characteristics”). If, for example, the user typically increases credit card spending during holiday seasons, the model can anticipate higher bill amounts during these periods (e.g., stored within the user activity data).

Referring now to FIG. 3 in more detail at block 330, the one or more processing circuits can generate and present a graphical user interface (GUI) including one or more actionable events associated with the plurality of performance parameters. In some embodiments, the one or more actionable events include events to increase the one or more performance indicators to or above the future performance indicator. For example, an actionable activity can refer to making a payment, automating future payments, remediating past payments, remediating past missed payments, consolidating lines of credit, generating a reward, performing a fraud check on exchanges, generating a notification, registering a new account or line of credit, paying a minimum, or other user activities. In another example, an actionable activity can refer to initiating a financial danger assessment, tailoring personalized financial products, or restructuring existing financial arrangements in alignment with the user's current financial standing. As such, the actionable activity can be one or more activities the user or computing systems can execute or perform to reach or progress to reaching a goal, such as qualify for a performance product. In general, some or more actionable activities can be configured to attempt to improve (e.g., if executed or performed) one or more performance indicators of the user (e.g., to qualify for a performance product). In some embodiments, the actionable events correspond to the future activity of the user. In some embodiments, the actionable events are below a user threshold. In some embodiments, configuring the actionable events is in response to generating a performance product with one or more performance parameters.

In some embodiments, GUI is generated and presented to depict an end goal (e.g., performance product) and to also highlight the actionable steps needed to achieve those performance parameters. Users can be presented with a roadmap that underscores both the performance product they can qualify for and the steps to get there. For example, if one of the performance parameters includes maintaining consistent monthly payments for a 12-month period to qualify for a particular loan product, the GUI might employ a dynamic progress bar that fills up with each on-time payment, offering a visual representation of the user's journey towards satisfying that specific parameter while likely also increasing their performance indicator to a desired future performance indicator. Accordingly, the GUI presents the performance product details, enumerating the performance parameters and the associated actionable events. The interface can feature a product description, a list of performance parameters linked with their respective actionable events, and a progress bar indicating the completion status. An acceptance button can be positioned for users to confirm their selection of the performance product. Once this button is activated, the processing circuits register the user's choice and begin monitoring the user's activity data, checking for the completion of the outlined actionable events. This continuous monitoring ensures that the user receives prompt feedback on their progress toward meeting the product's requirements.

In general, the actionable events highlighted by the GUI are tied to the performance parameters. Every action suggested or recommended can facilitate the user's path towards meeting these parameters. For example, when performance parameter is ‘consolidating lines of credit’, if the user has several credit lines with varied interest rates, the interface could highlight this as an actionable event and subsequently suggest optimal ways to consolidate these debts. This would align with the performance parameter but also potentially boosts their credit score (or a different performance indicator), thereby influencing their future performance indicator. Similarly, if a user needs to make reparations for past late payments to meet another performance parameter, the GUI could set up reminders or propose setting up automated payments. In another example, if one of the performance parameters is about opening a new savings account to show financial responsibility and stability, the GUI could streamline this process by offering an interactive guide or even partnerships with banking platforms for easy setup. For users who need to alter existing financial arrangements to meet certain performance parameters, an interactive financial modeling tool could be presented to let users experiment with different scenarios.

In some embodiments, the GUI can include options to accept one or more performance products. Upon navigating through the interface, users can be presented with an acceptance interface where they can formally accept the proposed performance product. The acceptance interface could include all the actionable events aligned with the performance parameters, presenting a view of the user's journey ahead. Moreover, to incentivize and motivate users, the GUI can showcase potential rewards that could be unlocked at various milestones during their journey. For those who are provided tiered performance products, a side-by-side comparison or a layered view might be available, allowing users to discern the benefits and requirements of each tier. With buttons or gestures, the user can then commit (e.g., accept) to their chosen performance product, set reminders for actionable events, and begin their journey towards achieving the desired future performance indicator.

In one example, a “Premier Checking Account” could be a performance product. To qualify, there may be specific performance parameters set by financial institutions. Firstly, prospective users may be expected to have a minimum credit score, which serves as a performance indicator, of 720. Moreover, the terms may stipulate that there should be a monthly deposit of at least $5,000 and the maintenance of a daily balance not falling below $10,000. Another condition could be the absence of any overdrafts in a year-long period. To help users reach these performance benchmarks, a series of actionable events can be presented on the GUI. In particular, users can be encouraged to settle any lingering debts or loan amounts. Another actionable event could be the timely payment of all due bills, particularly credit card balances. To facilitate this, the graphical user interface (GUI) can be programmed to send automated reminders or even help set up auto-pay features. Another event may be to open a savings account. Additionally, the GUI might emphasize the importance of a credit utilization ratio, advising users to maintain it below 30%. Moreover, users might have an event to attend financial counseling sessions. By following these actionable events through the guidance of the GUI, users do not just satisfy the criteria for the Premier Checking Account; they can also enhance their credit score, elevating their overall economic stature. The GUI serves as a companion in this journey, offering timely feedback, tracking milestones, and ensuring users are consistently informed and engaged.

Referring now to FIG. 3 in more detail at block 340, the one or more processing circuits can monitor the user activity data and the one or more performance indicators of the user based on receiving new activity data corresponding to the future performance indicator from a user data source. In some embodiments, the one or more processing circuits can remodel the user activity data based on an update to the user activity data to include the new activity data and, in response to remodeling the user activity data, determine the new activity data satisfies a performance threshold corresponding to at least one of the plurality of performance parameters. In some embodiments, the one or more processing circuits can receive a performance product update request from the user corresponding to an update to the plurality of performance parameters or an update to the one or more performance indicators and remodel the user activity data to generate at least one new performance product including a plurality of new performance parameters based on the update to the plurality of performance parameters or the update to the one or more performance indicators.

To monitor the user activity data, the processing circuits can employ a real-time (or near real-time) data retrieval mechanism that continuously syncs with a user's data source (e.g., user device 140 or data sources 170). This facilitates the extraction of any modifications, additions, or deletions in the user's activity. By utilizing API integrations, webhooks, or direct server-to-server connections, the processing circuits can access the latest user data, ensuring that actionable event completion is instantaneously captured. Moreover, security protocols and encryption can be maintained during this process, safeguarding user data from potential breaches and maintaining data integrity. In some embodiments, as users interact with various financial platforms or execute financial transactions, these engagements can generate data points which the processing circuits can capture.

Upon receiving new activity data, the processing circuits can initiate a remodeling phase. This can include recalibrating current models to integrate new user data points. Data preprocessing, normalization, and transformation provide that the new data aligns with the existing dataset's structure. Machine learning algorithms can also re-analyze the consolidated dataset, determining patterns and predicting the user's future financial behaviors. Performance product update requests can signify a user's evolving financial needs. When a user desires modifications to their current performance product-like adjusting a credit card's spending limit or changing a loan amount—the processing circuits execute a reevaluation process. This begins with adjusting the performance parameters to the user's new request. Depending on the extent of the change, actionable events and associated thresholds may be revised. For example, a request to increase a loan amount from $500k to $750k would necessitate altered performance parameters, potentially requiring a higher credit score threshold or additional actionable events to ensure that the user remains a viable candidate for the higher loan amount.

In one non-limiting example, a user may initially accept a performance product offering that is a $500k loan with a commitment to certain actionable events that would enhance their credit score. As the processing circuits monitor their mobile device, the processing circuits identify regular credit card payments and a significant debt reduction, signaling the completion of some actionable events. A few months later, the user, seeing steady financial growth, requests an updated loan amount of $750k. The processing circuits can recalibrate, integrating the new user data, and generate revised performance parameters tailored to the updated loan amount.

Referring now to FIG. 3 in more detail at block 350, the one or more processing circuits can determine whether the new activity data satisfies the plurality of performance parameters of the one or more performance products. In some embodiments, the processing circuits, upon receiving new activity data, initiate a comparison procedure. This procedure can contrast the user's activity data against the predetermined performance parameters associated with the chosen performance product. The processing circuits can evaluate each parameter, ensuring that each requisite condition, whether it pertains to transaction frequency, credit utilization, or other financial behaviors, aligns with the data. For example, if one of the performance parameters dictates a minimum monthly deposit into a specified account, the processing circuits would extract monthly deposit data from the recent activity and cross-reference this with the stipulated value. Similarly, if the performance parameters entail maintaining a certain credit utilization ratio for a specified duration, the processing circuits will assess the credit expenditure and available credit over the specified time period.

In some embodiments, if the activity data does not fulfill a specific performance parameter, the processing circuits might trigger alerts or notifications. These could be designed to inform the user about the discrepancies or even provide recommendations to achieve the desired parameter. Conversely, when the user's activity aligns with the set parameters, the processing circuits might generate and transmit confirmation notifications, reinforcing positive financial behaviors and potentially updating the user's status towards attaining the desired performance product. Furthermore, in certain embodiments, the processing circuits could employ machine learning models to predict whether the current trajectory of the user's financial behavior will lead to the fulfillment of all performance parameters in the stipulated timeframe.

In some embodiments, in response to the new activity data satisfying the performance threshold, provide and present a reward in the GUI, wherein the reward enables a feature of the GUI, and update a user client application to include the feature, wherein updating the user client application includes transmitting a set of instructions to the user client application stored on a user device of the user, wherein the set of instructions, when executed, cause the user client application to integrate the feature into the user client application. In some embodiments, once the processing circuits detect that the new activity data aligns with the prescribed performance threshold, the GUI may determine and present a reward. This reward could range from unique badges, points, or even access to advanced financial or economic tools within the application. For example, the reward might enable a detailed budgeting tool, an investment calculator, or specialized financial insights tailored to the user's activity. Further, in certain embodiments, once this reward is activated, a prompt might be generated in the GUI, guiding the user to initiate the update for their client application. The integration of this new feature into the user's client application could enhance user experience, streamline specific tasks, or offer new functionalities that were previously inaccessible. This integration process is facilitated through the transmission of a set of instructions from the server to the client application on the user's device. When this set of instructions is executed, it triggers the seamless incorporation of the rewarded feature, thus augmenting the user's client application capabilities.

In general, a performance threshold serves as a predefined benchmark or criterion that users must meet or exceed in relation to a specific performance parameter. The performance threshold can be considered as the measurable standard against which the actual outcome of a performance parameter is evaluated. It delineates the boundary between satisfactory and unsatisfactory performance. For example, if a performance parameter is set around maintaining a minimum monthly savings amount, the performance threshold might be set at $500. In this context, depositing anything equal to or above this amount would signify meeting the threshold, while any amount below this would indicate a shortfall. Accordingly, a performance threshold is a specific, quantifiable benchmark that defines the point of satisfaction or achievement for a given performance parameter. In contrast, an actionable event is a task or action that a user can undertake to influence or achieve a desired outcome in relation to the performance parameter, potentially helping them meet or surpass the associated performance threshold.

In some embodiments, upon the recognition by the processing circuits that the new activity data meets the desired performance threshold, the GUI may be programmed to display content items, symbolizing the user's achievement. For example, in a setting where a user is utilizing a financial app dedicated to savings, upon reaching a specified savings goal, a digital tree might grow on their dashboard, each branch representing a milestone achieved. In another example, users of a travel-focused credit card application might see a virtual globe, where new landmarks or flags appear as they spend in different countries, each landmark signifying rewards or points earned. As these rewards become available, the GUI might trigger notifications, urging the user to initiate an update for the application. With each update, additional functionalities or insights related to the user's spending patterns in various countries might be integrated. When the set of instructions are executed, these instructions enable the new features.

In some embodiments, in response to the new activity data satisfying the performance threshold, provide and present a reward in the GUI, wherein the reward unlocks at least one performance parameter, and update the plurality of performance parameters of the one or more performance products to indicate that at least one performance parameter is unlocked, wherein the update of the plurality of performance parameters includes either adding a new performance parameter or modifying a current performance parameter of the plurality of performance parameters. For example, once the processing circuits determine that the user's activity data is in accordance with the defined performance threshold, the GUI might offer a visual or audible alert, signifying the reward. This reward, in certain embodiments, could represent a symbolic unlocking of a performance parameter. That is, this could mean that users are either closer to their financial product goals or are given expanded choices in terms of product features. In some embodiments, the reward could mean the addition of a new performance parameter (e.g., a higher credit limit or access to specialized loan options). Conversely, it could entail the modification of an existing parameter, for example, reducing the requisite number of transactions needed or lowering the stipulated deposit amount for a particular financial product. Such adjustments, manifesting in real-time based on user activity, serve to maintain user engagement and foster a sense of accomplishment, guiding them closer to their desired financial objectives.

In some embodiments, the plurality of performance parameters are monitored over a time period, and the processing circuits can determine the progress of at least one of the plurality of performance parameters based on a current time in the time period and a completion level of the one or more actionable events, wherein the progress is above or below a projected threshold at the current time and provide and present a reward on the GUI, wherein the reward either (1) enables or disables another feature of the GUI, or (2) unlocks or locks at least one performance parameter of the one or more performance products. In some embodiments, the plurality of performance parameters are monitored over a set duration, such as monthly, quarterly, or annually. Within these defined timeframes, the processing circuits can track and evaluate user progress concerning the actionable events linked to these parameters. In some embodiments, this is accomplished by analyzing timestamps associated with each actionable event, allowing the processing circuits to gauge if the user is adhering to the projected timeline. In some embodiments, the processing circuits can compare the user's progress with a predefined benchmark or projected threshold. Depending on this assessment, adjustments can be made dynamically to the user's performance indicators, keeping them in sync with their actual progress. In some embodiments, if the user's progress surpasses the projected threshold at any given checkpoint within the time period, they might be rewarded. This reward could manifest as enhanced GUI features, making the user interface more interactive, user-friendly, or even gamified. On the contrary, if the user lags or fails to meet specific criteria, certain features on the GUI might be restricted or locked temporarily, serving both as a feedback mechanism and a motivator for the user to achieve their targets.

For example, consider a financial management application. Users who commit to saving a specific amount monthly might have performance parameters such as setting up an automated savings plan, attending financial literacy webinars, or limiting ATM withdrawals. As the end of the month approaches, the processing circuits assess if the user is close to achieving their savings goal. If the user has saved 90% of their target with a week left in the month, they are ahead of the projected threshold. Recognizing this achievement, the processing circuits generating and presenting the GUI might reward the user by unlocking an advanced budgeting tool or providing them with a more comprehensive spending analysis feature. Conversely, if they have saved only 20% with just a week remaining, certain premium features on the GUI might get locked, urging them to prioritize their financial commitments.

Referring now to FIG. 3 in more detail at block 360, the one or more processors can present one or more content items on the GUI including an indication of whether the user satisfies the plurality of performance parameters of the one or more performance products. In some embodiments, the processing circuits can determine whether the user satisfies the plurality of performance parameters or the updated plurality of performance parameters for at least one of the plurality of sub-performance products and provide and present at least one of the plurality of sub-performance products to the user in the GUI, including an interactable item to accept at least one of the plurality of sub-performance products. In some embodiments, the indication presented on the GUI serves as a feedback mechanism for the user. This feedback can manifest in various forms such as visual cues, progress bars, color-coded alerts, or specific numeric or textual indicators. For example, a progress bar could gradually fill as the user moves closer to satisfying a particular performance parameter. Alternatively, a color-coded system might utilize green to signify parameters that have been met, yellow for those nearing completion, and red for those yet to be significantly addressed.

In some embodiments, the GUI's indication acts as a confirmation mechanism for the user, signifying that they have successfully met the outlined performance parameters. These confirmations can come in the form of visual badges, ticks, completion percentages, or specific congratulatory messages. As an example, upon achieving a requisite credit score or fulfilling a debt clearance requirement, a “Congratulations” badge might appear, acknowledging the completion of a performance parameter. This recognition serves as a visual cue that the user has executed the necessary actionable events to reach the end goal, and it is now time for them to proceed to the next phase, which is acceptance.

Regarding the implementation of tiers or sub-performance products, upon meeting specific performance parameters, the user is then presented with the eligible tier they have unlocked. This segmentation ensures that the user is paired with the product most reflective of their achievements. On the GUI, the eligible sub-performance product or tier would be prominently highlighted, perhaps with an accompanying banner like “Eligible” or “Achieved”. Alongside this, an interactable item, such as a “Complete Acceptance” button or a “Finalize Product” link, would be displayed. By selecting this option, the user formalizes their commitment to the performance product they have worked towards, transitioning from the phase of striving to achieve the necessary parameters to the culmination of their efforts, which is the acceptance and integration of the performance product into their financial or economic portfolio.

In some embodiments, the processing circuits can automatically open or applying for a new line of credit (e.g., performance product) for the user on a time delay once the future performance indicator (e.g., FICO score) is obtained by the user (and sometimes after the performance parameters are achieved). In particular, a performance product could have previously (e.g., 3-months ago, 1 year ago) been accepted by the user with performance parameters including a future performance indicator. Accordingly, the processing circuits can automatically open the new line of credit in response to a performance indicator and/or performance parameters of the performance product being achieved. For example, a user attempting to qualify for a rewards credit card with premium perks might be set a target FICO score and performance parameters such as maintaining low credit utilization and timely payments over a six-month period. Upon achieving these stipulated criteria, the processing circuits can automatically initiate the credit card application for the user. As a reward for meeting the conditions, the processing circuits might either charge the user the card's annual fee or, as a promotional incentive, waive it for the first year, further incentivizing the user's engagement and commitment. In yet another example, if a user had opted into a performance product agreement a year ago, specifying that a credit line increase would be granted if the user reached a FICO score of 750 within 12 months, the processing circuits would monitor the user's FICO score progression. Upon recognizing that the user's score has reached the 750-mark within the stipulated timeframe, the system would initiate the process to enhance the user's credit line, with the increase becoming effective after a set time delay for validation and risk assessment purposes.

In yet another example, a user may express an interest in obtaining a mortgage. The processing circuits might present a performance product detailing the necessary performance parameters and future performance indicators the user must meet to qualify for the mortgage. Assume this includes achieving a specific FICO score, maintaining a consistent income, and showing a debt-to-income ratio within a defined range. Once the user accepts this performance product, the processing circuits monitor the user's financial data (e.g., activity data) over time, ensuring they meet the stipulated conditions. Upon recognizing that the user has satisfied the necessary performance indicator (e.g., attaining the required FICO score) and performance parameters (e.g., maintaining the desired debt-to-income ratio), the processing circuits can automatically initiate the mortgage application process on the user's behalf. In some arrangements, the automation includes gathering and submitting requisite documentation such as proof of income, credit report summaries, and relevant financial statements.

In some arrangements, the processing circuits can process a user's request for a specific performance product. The processing circuits can model user activity data and performance indicators, leading to two potential outcomes. The processing circuits can either provide the requested performance product with its unique parameters or suggests an alternative product with different parameters. This decision can be based on whether the processing circuits projects (using modeling) the future performance indicator to align with the product's requirements. For example, consider a user wanting to determine the FICO score required for a home mortgage with specific criteria. The user sets a target to reach this FICO score in six months. In response, the processing circuits formulates a strategy to achieve the desired credit score (e.g., actionable events). If the user successfully meets the target in the given period, the processing circuits can offer a rate lock as an incentive or reward. In particular, such a mechanism encourages clients to engage with their provider for loans, given the potential rewards for goal achievement. Beyond goal-setting, the processing circuits evaluates the feasibility of the user's objectives. If a goal seems unrealistic within the set timeframe, the processing circuits suggests other alternatives: a revised target, an extended duration, or a different financial product. For a user aiming to enhance their credit score for a premium credit card, rewards might include a waived annual fee or a one-time rebate upon opening a new account.

In some arrangements, the processing circuits employ a modeler, allowing users to set specific objectives related to performance indicators, such as a desired FICO score, savings target, or investment threshold. Once a goal is identified, the processing circuits generate a data-driven plan tailored to the user's current position and the intended performance indicator. Based on this plan, users might be offered certain conditional incentives, like improved interest rates. In some arrangements, the processing circuits constantly evaluates and monitors the likelihood of goal attainment. If a target appears unattainable within the preset parameters, the processing circuits can suggest adjustments, either in the form of goal modification, timeline extension, or introducing an alternative financial product more suited to the user's current situation. If, from the onset, the modeler determines a user's goal to be unachievable based on the initial data and parameters, the processing circuits can immediately flag this assessment. Instead of proceeding on a potentially futile path, the processing circuits can proactively offer alternative objectives or strategies to better align with the user's current status and potential growth trajectory.

Referring now to FIG. 4A, an illustration of a configuration of a user interface 400 on user device 140 is shown. The user interface 400 may be presented within the user client application 154. In some embodiments, the user interface 400 is generated and provided by the content control circuit 128. The content can contain an actionable activity or action. In some embodiments, the user interface 400 may contain one or more actionable (or interactable) buttons or items (e.g., 402, 404, 406, 408, and 410) that influences an actionable activity (e.g., select a performance product). In general, the user interface 400 of FIG. 4A depicts a curated list of performance products that the user could potentially qualify for based on their future performance indicator. Each item in the list corresponds to a different product or tier of financial offerings. For example, button 402 might lead to the “Autograph Product,” which is tailored to users with a specific credit score range or financial background. In some embodiments, the actionable button 402, if selected by the user, leads to a detailed overview of the “Autograph Product,” offering insights into the requirements, benefits, and potential actionable events linked with it.

Referring now to FIG. 4B, an illustration of a configuration of a user interface 400 on user device 140 is shown. The user interface 400 may be presented within the user client application 154. In some embodiments, the user interface 400 is generated and provided by the content control circuit 128. The content can contain an actionable activity or action. In some embodiments, the user interface 400 may contain one or more actionable (or interactable) buttons or items (e.g., 412, 414, 416, 418, and 420) that influences an actionable activity (e.g., review actionable events). In general, the user interface 400 of FIG. 4B depicts a dashboard of actionable events that the user needs to complete to attempt to qualify or obtain their selected performance product. This dashboard might be structured as a checklist or a progress bar, highlighting both completed and pending activities. Certain actions might be bolded or shaded to indicate their completion status. In some embodiments, the actionable button 418, if selected by the user, initiates a prompt for the user to set up bill pay, detailing the steps required for setup and the potential rewards for completion.

Referring now to FIG. 4C, an illustration of a configuration of a user interface 400 on user device 140 is shown. The user interface 400 may be presented within the user client application 154. In some embodiments, the user interface 400 is generated and provided by the content control circuit 128. The content can contain an actionable activity or action. In some embodiments, the user interface 400 may contain one or more actionable (or interactable) buttons or items (e.g., 424, 426, 430, and 432) that influences an actionable activity (e.g., review actionable events). In general, the user interface 400 of FIG. 4C depicts a detailed bill pay interface where users can oversee and manage their monthly bills. This section highlights each bill's specifics, such as the provider, amount due, and due date. In some embodiments, the actionable button 424, if selected by the user, allows them to access a submenu where they can define automatic payment rules, like paying the full amount or a set fraction every month. In some embodiments, the actionable button 426, if selected by the user, guides them through a step-by-step process to set up bill pay for a particular provider, ensuring seamless financial management.

Referring now to FIG. 4D, an illustration of a configuration of a user interface 400 on user device 140 is shown. The user interface 400 may be presented within the user client application 154. In some embodiments, the user interface 400 is generated and provided by the content control circuit 128. The content can contain an actionable activity or action. In some embodiments, the user interface 400 may contain one or more actionable (or interactable) buttons or items (e.g., 434) that influences an actionable activity (e.g., unlock a performance product). In general, the user interface 400 of FIG. 4D depicts a celebration of achievement, where the “Autograph Product” has been unlocked, reflecting the user's successful transition from a future performance indicator to a present one by completing required actionable events. The screen also prominently showcases the various rewards the user has earned along their journey to reach this point. In some embodiments, the actionable button 434, if selected by the user, allows them to officially accept the unlocked “Autograph Product” and view the associated benefits and terms in detail.

Referring now to FIG. 4E, an illustration of a configuration of a user interface 400 on user device 140 is shown. The user interface 400 may be presented within the user client application 154. In some embodiments, the user interface 400 is generated and provided by the content control circuit 128. The content can contain an actionable activity or action. In some embodiments, the user interface 400 may contain one or more actionable (or interactable) buttons or items (e.g., 436 and 438) that influences an actionable activity (e.g., select a sub-performance product or tiered performance product). In general, the user interface 400 of FIG. 4E depicts a layered visualization of tiered performance products. Each tier represents varying levels of financial offerings, with Tier #1, for example, associated with a more favorable interest rate due to stricter performance parameters. In some embodiments, the actionable button 436, if selected by the user, displays the requirements, benefits, and actionable events associated with Tier #1, giving users a comprehensive understanding of what they need to achieve to qualify.

Referring now to FIG. 4F, an illustration of a configuration of a user interface 400 on user device 140 is shown. The user interface 400 may be presented within the user client application 154. In some embodiments, the user interface 400 is generated and provided by the content control circuit 128. The content can contain an actionable activity or action. In some embodiments, the user interface 400 may contain one or more actionable (or interactable) buttons or items (e.g., 440, 442, 444, and 446) that influences an actionable activity (e.g., review locked and unlocked rewards). In general, the user interface 400 of FIG. 4F depicts a reward summary screen, showcasing the tangible benefits the user has unlocked, as well as those still pending. The interface highlights rewards in varying degrees of prominence based on their status: unlocked rewards might be bolded, while locked ones might appear more subdued. In some embodiments, the actionable button 444, if selected by the user, unveils the set of actionable events or performance parameters needed to access a decrease in interest rate, offering a clear pathway to enhanced product benefits when the user qualifies for the product.

It should be understood that no claim element herein is to be construed under the provisions of 35 U.S.C. § 112(f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A system comprising:
a processing circuit comprising memory and one or more processors, the processing circuit configured to:
identify user activity data and one or more performance indicators of a user;
model the user activity data to generate one or more performance products comprising a plurality of performance parameters corresponding to a future performance indicator of the user;
generate and present a graphical user interface (GUI) comprising one or more actionable events associated with the plurality of performance parameters;
monitor the user activity data and the one or more performance indicators of the user based on receiving new activity data corresponding to the future performance indicator from a user data source;
determine whether the new activity data satisfies the plurality of performance parameters of the one or more performance products; and
present one or more content items on the GUI comprising an indication of whether the user satisfies the plurality of performance parameters of the one or more performance products.

2. The system of claim 1, wherein the one or more performance products comprises a plurality of sub-performance products associated with tiers of performance, and wherein at least one of the plurality of sub-performance products correspond to at least one update to the plurality of performance parameters and at least one update to the one or more actionable events.

3. The system of claim 2, the processing circuit further configured to:
determine the user satisfies the plurality of performance parameters or the updated plurality of performance parameters for at least one of the plurality of sub-performance products; and
provide and present at least one of the plurality of sub-performance products to the user in the GUI comprising an interactable item to accept the at least one of the plurality of sub-performance products.

4. The system of claim 2, wherein the tiers of performance comprise (1) a first tier of a first sub-performance product of the plurality of sub-performance products corresponding to an updated plurality of performance parameters and an updated one or more actionable events, and (2) a second tier of a second sub-performance product of the plurality of sub-performance products corresponding to the plurality of performance parameters and the one or more actionable events, and wherein the plurality of performance parameters increases at least one economic attribute of the user compared to the updated plurality of performance parameters.

5. The system of claim 1, the processing circuit further configured to:
remodel the user activity data based on an update to the user activity data to comprise the new activity data; and
determine, in response to remodeling the user activity data, the new activity data satisfies a performance threshold corresponding to at least one of the plurality of performance parameters.

6. The system of claim 5, the processing circuit further configured to:
provide and present, in response to the new activity data satisfying the performance threshold, a reward in the GUI, wherein the reward enables a feature of the GUI; and
update a user client application to comprise the feature, wherein updating the user client application comprises transmitting a set of instructions to the user client application stored on a user device of the user, wherein the set of instructions, when executed, cause the user client application to integrate the feature into the user client application.

7. The system of claim 5, the processing circuit further configured to:
provide and present, in response to the new activity data satisfying the performance threshold, a reward in the GUI, wherein the reward unlocks at least one performance parameter; and
update the plurality of performance parameters of the one or more performance products to indicate the at least one performance parameter is unlocked, wherein the update of the plurality of performance parameters comprises either adding a new performance parameter or modifying a current performance parameter of the plurality of performance parameters.

8. The system of claim 1, the processing circuit further configured to:
receive a performance product update request from the user corresponding to an update to the plurality of performance parameters or an update to the one or more performance indicators; and
remodel the user activity data to generate at least one new performance product comprising a plurality of new performance parameters based on the update to the plurality of performance parameters or the update to the one or more performance indicators.

9. The system of claim 1, wherein the plurality of performance parameters are monitored over a time period, and the one or more processors are further configured to:
determine progress of at least one of plurality of performance parameters based on a current time in the time period and a completion level of the one or more actionable events, wherein the progress is above or below a projected threshold at the current time; and
provide and present a reward on the GUI, wherein the reward at least one of (1) enables or disables another feature of the GUI, or (2) unlocks or locks at least one performance parameter of the one or more performance products.

10. The system of claim 1, wherein the one or more actionable events comprise events to increase the one or more performance indicators to or above the future performance indicator, and the processing circuit is further configured to:
receive a request for a specified performance product of the user; and
modeling the user activity data to generate at least one of (1) the specified performance product comprising unique performance parameters, or (2) an alternative performance product comprising alternative performance parameters, wherein the specified performance product is generated in response to the modeling determining the future performance indicator corresponding with the specified performance product is achievable, and wherein the alternative performance product is generated in response to the modeling determining the future performance indicator corresponding with the specified performance product is unachievable.

11. A method comprising:
identifying, by one or more processing circuits, user activity data and one or more performance indicators of a user;
modeling, by the one or more processing circuits, the user activity data to generate one or more performance products comprising a plurality of performance parameters corresponding to a future performance indicator of the user;
generating and presenting, by the one or more processing circuits, a graphical user interface (GUI) comprising one or more actionable events associated with the plurality of performance parameters;
monitoring, by the one or more processing circuits, the user activity data and the one or more performance indicators of the user based on receiving new activity data corresponding to the future performance indicator from a user data source;
determining, by the one or more processing circuits, whether the new activity data satisfies the plurality of performance parameters of the one or more performance products; and
presenting, by the one or more processing circuits, one or more content items on the GUI comprising an indication of whether the user satisfies the plurality of performance parameters of the one or more performance products.

12. The method of claim 11, wherein the one or more performance products comprises a plurality of sub-performance products associated with tiers of performance, and wherein at least one of the plurality of sub-performance products correspond to at least one update to the plurality of performance parameters.

13. The method of claim 12, further comprising:
determining, by the one or more processing circuits, the user satisfies the plurality of performance parameters or the updated plurality of performance parameters for at least one of the plurality of sub-performance products; and
providing and presenting, by the one or more processing circuits, at least one of the plurality of sub-performance products to the user in the GUI comprising an interactable item to accept the at least one of the plurality of sub-performance products.

14. The method of claim 12, wherein the tiers of performance comprise (1) a first tier of a first sub-performance product of the plurality of sub-performance products corresponding to an updated plurality of performance parameters and (2) a second tier of a second sub-performance product of the plurality of sub-performance products corresponding to the plurality of performance parameters, and wherein the plurality of performance parameters increases at least one economic attribute of the user compared to the updated plurality of performance parameters.

15. The method of claim 11, further comprising:
remodeling, by the one or more processing circuits, the user activity data based on an update to the user activity data to comprise the new activity data; and
determining, by the one or more processing circuits in response to remodeling the user activity data, the new activity data satisfies a performance threshold corresponding to at least one of the plurality of performance parameters.

16. The method of claim 15, further comprising:
providing and presenting, by the one or more processing circuits in response to the new activity data satisfying the performance threshold, a reward in the GUI, wherein the reward enables a feature of the GUI; and
updating, by the one or more processing circuits, a user client application to comprise the feature, wherein updating the user client application comprises transmitting a set of instructions to the user client application stored on a user device of the user, wherein the set of instructions, when executed, cause the user client application to integrate the feature into the user client application.

17. The method of claim 15, further comprising:
providing and presenting, by the one or more processing circuits in response to the new activity data satisfying the performance threshold, a reward in the GUI, wherein the reward unlocks at least one performance parameter; and
updating, by the one or more processing circuits, the plurality of performance parameters of the one or more performance products to indicate the at least one performance parameter is unlocked, wherein the update of the plurality of performance parameters comprises either adding a new performance parameter or modifying a current performance parameter of the plurality of performance parameters.

18. The method of claim 11, further comprising:
receiving, by the one or more processing circuits, a performance product update request from the user corresponding to an update to the plurality of performance parameters or an update to the one or more performance indicators; and
remodeling, by the one or more processing circuits, the user activity data to generate at least one new performance product comprising a plurality of new performance parameters based on the update to the plurality of performance parameters or the update to the one or more performance indicators.

19. The method of claim 11, wherein the plurality of performance parameters are monitored over a time period, and the method further comprising:
determining, by the one or more processing circuits, progress of at least one of plurality of performance parameters based on a current time in the time period and a completion level of the one or more actionable events, wherein the progress is above or below a projected threshold at the current time; and
providing and presenting, by the one or more processing circuits, a reward on the GUI, wherein the reward at least one of (1) enables or disables another feature of the GUI, or (2) unlocks or locks at least one performance parameter of the one or more performance products.

20. A non-transitory computer-readable storage medium (CRM) having instructions stored thereon that, when executed by a processing circuit, cause the processing circuit to perform operations comprising:
identifying user activity data and one or more performance indicators of a user;
modeling the user activity data to generate one or more performance products comprising a plurality of performance parameters corresponding to a future performance indicator of the user;
generating and present a graphical user interface (GUI) comprising one or more actionable events associated with the plurality of performance parameters;
monitoring the user activity data and the one or more performance indicators of the user based on receiving new activity data corresponding to the future performance indicator from a user data source;
determining whether the new activity data satisfies the plurality of performance parameters of the one or more performance products; and
presenting one or more content items on the GUI comprising an indication of whether the user satisfies the plurality of performance parameters of the one or more performance products.
